(19) United States
(12) Patent Application Publication
(10) Pub. No.: US 2021/0097212 A1
(43) Pub. Date: Apr. 1, 2021

(54) CALIBRATION IN A DIGITAL WORK FLOW

(71) Applicant: Denta Vision GmbH, Berg (CH)

(72) Inventor: Alwin Schönenberger, Berg (CH)

(21) Appl. No.: 17/049,392

(22) PCT Filed: Apr. 23, 2019
(86) PCT No.: PCT/EP2019/060277

§ 371 Date: Oct. 21, 2020

(30) Foreign Application Priority Data
Apr. 23, 2018 (CH) 00522/18

(51) Int. Cl. G06F 30/10; G09B 23/28; G01B 21/04; G01B 11/24; A61C 13/00

(52) U.S. Cl. CPC G06F 30/10; G09B 23/283; G01B 21/042; A61C 13/0018; A61C 13/0004; A61C 13/0019; G01B 11/24

(57) ABSTRACT

A method for the calibration of a data acquisition device and a peripheral device, in particular a CAD miller, 3D printer or a laser for laser sintering, to test bodies which have been developed for carrying out this method and to sets which include these test bodies as well as test pins which match these.

### BACKGROUND OF THE INVENTION

### Field of the Invention

The invention relates to a calibration method, with the help of which various devices can be optimally matched to one another in the digital workflow, so that workpieces that are as accurately fitting as possible arise at the end of the production process. In particular, the invention relates to methods for the calibration of a data acquisition device and of a peripheral device (in particular a CAD miller, 3D printer or laser for laser sintering) to test bodies that have been developed for carrying out this method and to sets that include these test bodies as well as test pins matching these and possibly digital data sets of the test body.

In the field of dental restorative medicine, CAD/CAM technology has accomplished a clear breakthrough. Digital technologies have become established in dental practices as well as in the dental laboratory and have led to significant changes in diagnostics, planning and therapy. Digital imaging, virtual planning of surgical and prosthetic measures as well as CAD/CAM assisted manufacturing methods form a complete digital workflow that is applied in classical restorative therapy to natural teeth as well as in oral implantology. An advantage of digital workflow lies in the application of high-quality materials that can be processed in an exclusively industrial manner, such as for example zirconium dioxide. Herein, a digital scan takes place in the dental practise, the data is sent to a laboratory, which assumes the CAD planning, the CAM (computer aided manufacture) of the workpieces and the control of the fit. The application of restorations subsequently takes place in the dental practice.

The quality and accuracy of the produced workpieces is influenced by the tolerances of the devices that are applied on data acquisition (scanners) and in the production (CAD millers or 3D printers). These tolerances can compromise the ideal fit of the workpieces to the anatomical structures or even render such impossible. The precision of the manufactured workpieces amongst other things depends on the peripheral devices which obtain their basic data from the acquisition devices. The peripheral devices are manufactured in a mechanical production. This production is only accurate to a limited extent (tolerance). The tolerance is due to the mechanical construction of the devices and their mechanical capacity to produce three-dimensional bodies from electronic data. The basic tenet is: each device produces differently—each device is unique.

The patent application DE 10 2004 022 750 A1 relates to micro test bodies for measuring and examining dimensional measuring devices. The test body has several pyramids that are arranged on a surface that has arisen due to impressing an arrangement of pyramids, which have been etched in a silicon wafer. The test body has no structure that, after the meshing of the positive part and negative part, forms an oblique contact surface, which tapers to the surface of the test body and is not therefore optimal for a calibration of devices with regard to the manufacture of dental, prosthetic workpieces.

It is particularly in the dental-medical and dental-technical production process that a high precision is necessary. Despite an optimisation of conventional impression techniques or of the scanning methods in the dental practise, inaccuracies on creating the model as well as with the manufacturing process of the prosthetic workpieces until now have had to be reckoned with, such rendering necessary a manual post-machining. The manual post-machining of workpieces from the digital workflow until now has been an unavoidable necessity, even if the digital workflow does not begin until the scanning of a plaster model, thus is carried out in combination with the classical technique of impressing and model creation. This combination technique has been practiced until now in 90% of the cases. The impressing with a high-precision impression mass represents the actual data acquisition of the anatomical structures in analogue form and serves as a basis for the creation of a plaster model. It is only beginning with his model that a digital data set is created by way of scanning the plaster model by way of a scanner. The analogue plaster model can to the same extent display significant differences to the actual anatomical structures (deformation, shrinkage expansion etc.). However, such inaccuracies can also arise with the direct method, i.e. with the intraoral scan. Regardless of the selected procedures, whether purely digital or analogue and digital combined, manual post-machining has hitherto been necessary for optimising the margin and the fit. The workpieces from digital or analogue-digital production in contrast need to be termed as semi-finished parts, since manual corrections are essential for optimising the precision. Extensive manual post-machining however needs to be avoided or reduced to a minimum, since this increases the manufacturing costs and manufacturing time and can significantly reduce the quality. With regard to this, the most important problems are either workpieces that are dimensioned too small and that prevent them being pushed over the natural or implant posts, or workpieces that are dimensioned too large and that render impossible a stress-free insertion into a cavity or negative shape. The fit can therefore only be accomplished by way of widening out (internal grinding) or reducing (external grinding) of the parts. The minimum material thickness, which is specified in the software and in the CAD design, cannot be fallen short of due to this measure. Additionally, a compromise of the stability shape that protects the workpiece from rotation movements and tilting movements is possible.

With manual post-machining, the workpieces are changed by way of grinding. The relatively uncontrolled removal of material, although being able to sometimes improve the precision (margins), however simultaneously leads to the reduction of the material thicknesses which are defined in the planning and implemented in the production process. The defined material thicknesses and tolerances guarantee the mechanical strength of the workpieces and their optimal fit, two fundamental preconditions for the long-term success. If a workpiece is machined manually, the control of the two aforementioned criteria is lost.

The fitting accuracy of the produced workpieces is of utmost importance due to the fact that they can be pushed onto or into respective anatomical structures by way of joining or bonding technology. In order for this connection to permanently function, a fitting gap of 50 microns is necessary based on scientific evidence. If the gap is too large or to small, the long-term success of the joining method or bonding method is compromised.

The inventor could observe that a reason for the occurring inaccuracies lies in the fact that devices in combination does not necessarily provide the desired manufacturing precision and a matching between the devices with a fine adjustment is absolutely necessary. Each device has a characteristic tolerance, i.e. the deviation in the individual precision and manufacturing strategies, the deviation being specific to each device. Such circumstances relate to all devices in the digital workflow (data acquisition devices and peripheral devices). This inevitably leads to uncontrollable end results when these devices operate in conjunction, even if each of the devices per se is set correctly and correctly operated.

The inventor could develop a special method for calibration that is suitable for the matching of different devices. This method is to ensure more precise workpieces by way of a controlled and standardised manufacturing process. By way of this, the necessity of manual post-machining of workpieces can be reduced to a minimum and can lead to a significant improvement in the quality. It is therefore the object of the present invention to permit a matching or coordination of the data acquisition device and various peripheral devices by way of standardised calibration and parameterisation.

### SUMMARY OF THE INVENTION

This object is achieved by a method for calibrating a data acquisition device and a peripheral device, in particular a CAD miller, 3D printer or a laser sintering device, including the following steps:
a) providing a standardised test body which consists of a positive part and a negative part and includes a standardised, digital data set of the three-dimensional data of the negative part of the test body as a shape master;
b) acquiring three-dimensional data of the positive part of the standardised test body by the data acquisition device to be calibrated and generating a corresponding digital data set of the positive part of the standardised test body;
c) importing the digital data set from b) into CAD software and loading a standardised, digital data set from a);
d) designing the negative part with the help of the digital data set from b), the standardised digital data set from a) and the CAD software from c);
e) producing a negative part amid the use of the design from d) and the peripheral device to be calibrated; and
f) examining the fitting accuracy between the negative part from step e) and the positive part of the standardised test body.

The methods according to the invention permit a matching or the coordination between the data acquisition device and peripheral device. The data acquisition device to be calibrated and the peripheral device herein form a pair or a unit that are thus to also interact given future production sequences. Such a matching is necessary, so that precisely fitting workpieces can be created with an adequate precision. The methods according to the invention are to permit the acquisition of the correct (optimised) parameters or settings for a very specific device combination.

The methods according to the invention are particularly suitable for calibrating devices in the digital workflow in dental medicine. For this reason, preferred data acquisition devices are scanners, above all 3D scanners as well as computer tomographs, in particular devices for digital volume tomography (DVT). Preferred peripheral devices are devices or facilities for the additive or reductive manufacture and include the group consisting of: CAD millers, 3D printers and lasers, in particular lasers that are suitable for laser sintering or selective laser melting, as well as facilities for electron beam sintering. Generally, the term “data acquisition device” in the context of the present invention encompasses all devices that permit the modelling of an object true to reality and the acquisition of data on its three-dimensional shape and appearance. The term “peripheral device” as is used herein denotes all devices that are used to produce a workpiece from a digital 3D model of this workpiece.

In particular, if the data acquisition or scanning process takes place at an external customer (e.g., dental practise), for whom the data is processed in a production centre (e.g., dental laboratory, milling centre) (the two devices and their devices groups are not in the same room and are operated by different persons), the calibration of the devices amongst one another is decisive for the success.

With regard to the matching, the setting parameters and the tolerances of the data acquisition device and of the peripheral device are optimised to one another. Numerous setting parameters in the respective software modules of the devices are responsible for the tolerance values. The adjustment of the setting parameters is envisaged and desired by the manufacturer of the devices. Other device-specific characteristics such as optics elements and mechanics elements and their interaction have a considerable influence on the operating manner of the devices. The sum of all settings to one another determines the quality of the end product.

The calibration is effected by way of standardised test bodies. This preferably consist of 2 solid bodies, a positive part and a negative part. The positive part and the negative part as a male part and female part engage into one another in an as exactly fitting as possible manner. Additionally, standardised digital data sets of the two parts of the test body are also present as a shape master. They are each loaded into the design software and permit the user to design the workpiece to be produced in an efficient manner on the screen. For this, it is preferably the so-called matching method which is used, concerning which the digital picture of a part of the test body (for example, positive part) and the shape master of the counter-piece which matches this (for example, negative part) are coordinated with one another and joined together. The shape master can subsequently be changed with regard to size and design within the parameters that are demanded by the design software. The shape, size and design of the shape masters can be adapted to the workpieces that are to be manufactured. Suitable test bodies, which have been specially developed for the method for calibration which is described herein, are a further aspect of the present invention and are described further below in a detailed manner. Furthermore, a method according to the invention, concerning which one of the test bodies which is described herein is used, is preferred.

A suitable test body always consist of two parts: a positive part (male part) and a negative part (female part). Herein, the positive part or the male part is the counter-piece to the negative part or the female part. Both for example can include structures that engage into one another. It is preferable for the positive part and the negative part to engage into one another in an exactly fitting manner. The positive part and negative part should preferably fit together or engage into one another with a high precision (max 0.050 mm deviation and gap width between the parts) and even further preferably fit together or engage into one another with the greatest possible mechanical precision (max 0.010 mm deviation or gap width between the parts). With regard to the design and material, the bodies are manufactured such that the tolerance of the two parts (positive part and negative part) to one another is not more than 0.1 mm, preferably not more than 0.05 mm and particularly preferably not more than 0.010 mm.

The method basically functions regardless of whether in step b) three-dimensional data of the positive part or of the negative part of the test body are acquired. For this reason, a further embodiment of the present invention is a method for the calibration of a data acquisition device and a peripheral device (CAD miller and 3D printer or further developments of peripheral devices) including the following steps:
a) providing a standardised test body, which consists of a positive part and of a negative part, and a standardised digital data set, which includes the three-dimensional data of the positive part of the test body as a shape master;
b) acquiring three-dimensional data of the negative part of the standardised test body from a) with the data acquisition device to be calibrated and generating a corresponding digital data set of the negative part of the standardised test body,
c) importing the digital data set from b) into CAD software and loading the standardised digital data set from a);
d) designing the positive part with the help of the digital data set from b), the standardised digital data set from a) and the CAD software from c);
e) producing the positive part amid the use of the design from d) and the peripheral device to be calibrated; and
f) examining the fitting accuracy between the positive part from step e) and the negative part of the standardised test body from a).

Instead of calibrating a data acquisition device and a peripheral device, one could also speak of parameterisation. In the methods according to the invention, settings or parameters of device pairs, which are to be calibrated, are adjusted until the two devices are optimally matched to one another, so that they function as a production unit (for example the scanner and the 3D printer or the scanner and the CAD miller).

For this reason, a preferred embodiment of the method according to the invention relates to the additional following step g) and/or the following step h):
g) repeating the steps c) to f) and herein adapting or optimising the parameters of the CAD software and the device parameters until the fitting accuracy in step f) lies in the range of predefined tolerances and
h) acquiring and storing the adapted or optimised parameters.

The adapted and optimised and hence also the formulated and stored parameters can be parameters of the CAD software. However, they can also be parameters of the respective devices which are to be calibrated, in particular of the peripheral devices. Inasmuch as the fitting accuracy is already achieved with the first run of the method according to the invention (steps a) to f)), thus lies in the range of predefined tolerances, step g) is done away with and step h) can be directly subsequent to step f). As a result, step g) is optional or only necessary as long as the predefined tolerance of the fitting accuracy is not achieved. Step h) is likewise optional. Inasmuch as the peripheral device only obtains data from a certain data acquisition device (a few of them), the parameters can also be retained as unchanged in the CAD software and in the peripheral device. It is likewise possible, even if somewhat more complicated, to carry out the methods according to the invention for calibration afresh for each device repair before a new production. The calibration (or alternatively matching) is hence to be effected such that a specific device pair of a data acquisition device and a peripheral device are calibrated amongst one another. Since each device has its own tolerance, a general calibration of whole groups of devices does not lead to success.

Herein, it is to be noted that a certain scanner can be coupled to different peripheral devices (for example from a different production facility) and that one can carry out calibrations/parameterisations for each of these conceivable constellations. Conversely, a given peripheral device can be “served” by different scanners. In this case too, one can carry out specific settings. The calibration methods according to the invention therefore encompass a device matching by way of adjusting the setting possibilities in the software modules of the devices or in the devices themselves. Herein, the methods can take into account the operating manner which is specific to the device.

In order for such to succeed, the operator of a peripheral device can store the adapted or optimised parameters of a certain device pair in a data bank and possibly fall back on them. This means that given the submission of an order and corresponding digital data, the optimised parameters, which match the device with which the incoming data were detected, can be used in a rapid and uncomplicated manner.

Concerning a preferred embodiment of the method according to the invention, in step b) the acquisition of three-dimensional data of the negative part or of the positive part is effected by way of scanning (preferably with the help of a 3D scanner). The selection for the matching part (positive part or negative part) of the test body can be freely effected by the user. However, there are situations or projects that lead to the preference of one part. The scanning of the positive part is preferred if above all a direct scan of the oral situation or an indirect scan of the oral situation is to be effected later by the data acquisition device to be calibrated. With regard to the direct scan, it is exclusively a digital data set, which is created by way of an intraoral scanner and without making an analogue impression by way of an impression mass, whereas with the indirect scan a plaster model is firstly created, which is then scanned. Concerning the plaster model, an impression of the oral situation is made beforehand by way of an impression mass; the arising impression (negative shape) is then cast out with plaster (positive shape) and subsequently scanned. Common impression masses are elastomers based on silicone or polyether.

The scanning of the negative part is preferred if a model of the scanned oral situation is to be produced by way of 3D printing. In this case, no impression and no plaster model are to be produced. The scanned data of the oral situation is converted directly into a 3D printed model (positive shape). The printed model is examined by way of the negative part of the test body. If the negative part of the test body can be precisely joined into the printed model, then this proves that the 3D printer operates correctly, thus a correct positive part is created. If therefore the peripheral device that is to be calibrated is a CAD miller, then it is more the case that the positive part of the standardised test body is scanned and the negative part, which is to match with the positive part of the test body, is produced. On examining and calibrating a 3D printer, it tends to be the negative part of the standardised test body that is scanned and the positive part that is to match with the negative part of the test body, which is produced.

Step b) of the methods according to the invention further includes the generation of a digital data set. The data acquisition device or the scanner acquires the analogue data of the physical model, thus of the part of the test body that is to be scanned, with the help of sensors and subsequently converts these into digital form with A/D converters. This digital data set, thus the generated, digital 3D model of the scanned part of the standardised test body can be exported into various file formats, sent to other devices and processed further with arbitrary CAD and 3D programs. It is preferable for this digital data set to be present or created in STL format (stereo lithography or standard tessellation language format).

Hence methods according to the invention, concerning which the digital data set that is created in b) and the standardised data set are present and transferred in STL format, are preferred. The digital data set that is created in b) can possibly be transferred from the location of acquisition (e.g., dental practise) to an arbitrary production location (e.g., dental laboratory).

The STL format describes the surface of 3D bodies with the help of triangular facets (tessellation). Each triangle facet is characterised by the three corners points and the associated surface normals of the triangle. However, other formats which describe the 3D data and are read by CAD programs are possible, such as VRML format or additive manufacturing file format (AMF).

The digital data set from b) of the methods according to the invention can be processed by way of any CAD software. Programs that are common in the field of dental medicine are: Excocat, 3Shape, Dental Wings, Planmec and further products that are based on these. Generally, the term CAD (computer-aided design) software denotes computer programs that permit the creation of technical drawings on the computer. For instance, building plans and circuit plans can be drawn or 3D models of components can be created with the respective programs. In the context of this application, the term “CAD software” denotes all software solutions that permit a computer-assisted generation and modification of a geometric model for the purpose of the production of counter-pieces, which can be inserted into one another in an exactly fitting manner. The software product is freely selectable, but preferably however should be matched to the specifications of the manufacturer of the peripheral device. Basically, all design software products are suitable for the parameterisation. However, it is preferable for the software for the calibration of the devices to be used, with which as a result the actual production process is controlled. One aspect herein therefore relates to a computer-implemented method for planning and manufacture of prosthetic workpieces.

A standardised, digital data set of three-dimensional data of the positive and of the negative part of the standardised test body should be stored in the applied CAD software. These standardised, digital data sets should preferably be made available together with the test body and preferably be present in the same data format (preferably STL) as the data sets that are created in b). The standardised digital data sets preferably include all 3D parameters of the associated test body.

After step c) of the methods according to the invention, at least the following data sets are present in the used CAD software:
a digital data set of a positive part or a negative part of the standardised test body, which has been produced on scanning the respective positive part or negative part of the standardised test body by way of the data acquisition device to be calibrated (scan-procedure/step b) of the methods according to the invention) and
a standardised digital data set of three-dimensional data of the counter-piece of the standardised test body.

During the methods according to the invention, in step b) the counter-piece thus the positive part of the standardised test body is scanned for the production of a negative part and the negative part of the standardised test body is scanned for the production of a positive part. Furthermore, the standardised, digital data set of the negative part is loaded for the production of a negative part, and the standardised digital data set of the positive part of the standardised test body is loaded for the production of a positive part. In step d) of the methods according to the invention a definitive design of the workpiece to be produced is created with the help of these data sets and amid the use of the CAD software. The digital data of the definitive design can be read by the peripheral devices and then serve as a basis for the production of the workpieces (negative part or positive part).

A further embodiment of the present invention relates to a method for calibrating a data acquisition device and a peripheral device, wherein step d) includes a matching of the three-dimensional, digital data from a) and the standardised, digital data set from b). The matching lies in matching or merging the data set from b) and the standardised data set from a) to and with one another. In this embodiment, step d) can also be as follows:
d) matching (“coordinating”) the digital data set from b) and the standardised digital data set of the positive part of the standardised test body from a) with the help of CAD software from c) and carrying out further design steps for creating the design of the negative part by way of CAD software; or
d) matching (“coordinating”) the first digital data set from b) and the standardised digital data set of the negative part of the standardised test body from a) with the help of the CAD software from c) and carrying out further design steps for creating the design of the positive part by way of CAD software.

The matching ensures that the design of the produced workpieces arises from the shape master. By way of this, the process also becomes more efficient. The standardised, digital data sets provide the basic shape of the workpieces to be produced. Subsequently to the matching, all production parameters are added to the final design of the workpieces in the course of the CAD design. It is only with this that the design becomes complete and individual. The subsequent production is variable precisely due to this operating manner which is specified in the design program. This procedure is therefore provided in all design software. It is not until the working step d) that the parameterisation and the production of the workpieces are permitted. The desired standardisation of the individually settable parameters arises.

It is not until in step d) and possibly after the matching that the actual workpiece (positive part or negative part) is formed during the further design steps from the shape master and amid the use of the variable setting in the design software module.

The designs that are created in step d) can be sent to the peripheral device as digital data (preferably STL files) and be prepared for the production. In the peripheral device, the position of the workpiece is specified in the material blank (presentation of the raw product), e.g., by way of the so-called “nasting”. Milling strategies are defined and optimised by the user. In this working step, further parameters are led to the design, such parameters able to have a significant influence on the produced workpiece. The device-specific characteristic are hence incorporated into the final shape of the workpieces. Firstly, the user can select the parameters of the peripheral device to be calibrated, on the basis of his standard settings, or he selects the parameters on the basis of his routine or his experience. These parameters are possibly adapted further given a repetition of the steps c) to e) (corresponds to optional step h) until the predefined tolerance ranges are no longer exceeded. Herein, the user can fall back on his knowledge of the devices and their parameters. It is particularly with the first calibrations that a certain testing-out and trial and error can hardly be avoided.

A preferred method therefore relates to the methods according to the invention including a step e) which is defined as follows:
e) the production of the negative part or the positive part amid the use of the design from d) and the peripheral device to be calibrated including the setting of further variable parameters of the peripheral device to be calibrated.

After the effected design, the desired workpiece (positive part or negative part) is therefore manufactured in the specified manner, is subjected to the necessary treatments and brought into the final shape, as is envisaged by the actual production or manufacturing process. In step e) of the methods according to the invention therefore, a workpiece is produced on the basis of the design from step d) with the help of the peripheral device to be calibrated. Herein, the workpiece corresponds to the counter-piece of the part of the test body that is scanned in step b) and if the negative part is scanned then the produced workpiece is a positive part and vice versa. Herein, at least the production step or processing step, which is carried out by or with the peripheral device to be calibrated, must be carried out. It is indeed possible for not all processing steps to be carried out; the fitting accuracy is therefore tested on a workpiece that is situated in a raw state or in an unfinished state. A preferred method, however, relates to methods according to the invention including a step e) which is defined as follows:
e) the production of a negative part or the positive part including all processing steps amid the use of the design from d) and the peripheral device that is to be calibrated, or
e) the production of the negative part or of the positive part including all processing steps amid the use of the design from d) and the peripheral device to be calibrated including the setting of further variable parameters of the peripheral device to be calibrated.

In particular, if the peripheral device to be calibrated in a CAD miller, it can also be useful not to complete all further processing steps or to examine these separately. The examination of the fitting accuracy in step f) then above all represents the control of the milling accuracy. In such a case, step e) preferably does not include the further processing steps such as sintering. A milled workpiece, depending on the used material or depending on the marketed mark product of the same material (e.g., zirconium dioxide) presents itself by being 18%, 19% or 20% larger than after the completion of the subsequent sintering process. In order to be able to calibrate the miller independently of and depending on the subsequent sintering, a test body (and a corresponding standardised digital data set) that is larger by the volume percent magnitudes, by which the workpieces shrink on sintering according to experience, must possibly be selected. The test body should therefore correspond to a workpiece that is situated in the raw state. Herewith, the pure milling precision of the milling device to be calibrated can be determined and adjusted in a direct manner, without the subsequent working steps (sintering) influencing these results.

The workpieces are manufactured under production conditions that can differ greatly for different materials. The necessary minimum layer thicknesses as well as the connection locations of the elements of the workpieces can be tested in regard to the mechanical strength and shape stability with the methods according to the invention. Furthermore, further subsequent production steps such as sintering or thermal treatments and their course and temperature settings can also be examined.

The production in step e) is therefore different depending on the material. Concerning workpieces of zirconium dioxide, after their design the workpieces are milled out of a blank or ingot. Depending on the height of the required workpieces, blanks are available in different thickness and diameters. Raw zircon, colour pigments and other additives and ceramic crystals are thoroughly mixed and pressed together at a high pressure in this blank. The milled, unsintered raw material pieces are very fragile (susceptible to knocks and breakage). Furthermore they are over-dimensioned; they are between 18 and 20% larger than the expected workpiece. Each blank has a barcode with an exact shrinkage coefficient. The peripheral device reads and registers the shrinkage coefficient and derives a part of the milling strategy from this. After the careful cleaning of these raw workpieces (remaining milling dust in the workpieces that also co-sinter prevents an exactly fitting result) the latter are subjected to a complex heat treatment. This treatment is called sintering (melting together, flowing together). Given this opportunity, the workpiece melts together and reduces its volume by the mentioned shrinkage coefficient. Special sintering furnaces are necessary for this. The material zirconium dioxide obtains its hardness of up to 1400 Mp and its definitive volume by way of the sintering.

The laser sintering for the manufacture of precisely fitting metal frameworks (which are also veneered with ceramic by hand by the dental technician) in the first working operation includes the layering of pulverised material on one another by way of a laser beam. These smallest of metal balls are thus shaped into a solid and very delicate body. It is a generative, computer-assisted layering method.

Metallic workpieces, which are manufactured by way of laser sintering, for hardening are firstly subjected to a stress-relieving firing (oxide firing), which takes place at a temperature of approx. 960 degrees ° C. (depending on the metal basis). With this working procedure, a relaxation of the crystal structure of the metal occurs. Large distortions in the framework structure occur with this working step for reason of the relaxation. The framework must be rendered exactly fitting again by way of mechanical processing/machining. A shape that minimises an uncontrolled deformation can be given to the laser-sintered bodies by way of the method for calibration according to the invention. The size and the extent of the distortion are dependent on the material.

A fit arises subsequently to the production and possibly to the necessary further working steps (sintering, hardening of the materials) of the manufactured workpieces (negative part or positive part from step e)) by way of the inserting the produced workpiece and the counter-piece of the provided standardised test body into one another or by placing them upon one another. An examining of the fitting accuracy between the positive part (or negative part) from step e) and the negative part (or positive part) of the standardised test body from a) therefore takes place in step f). The “examining of the fitting accuracy” herein includes joining into one another or putting together of the manufactured workpiece (negative part or positive part from step e)) and the counter-piece of the provided standardised test body, as well as the acquisition/scanning and possible measurement of possible distances, free spaces or gaps between the two parts that are joined into one another or are put together. Furthermore, a comparison of the detected or measured data from this step with predefined tolerance ranges can be a part step to step f) of the method according to the invention.

An alternative formulation of step f) is therefore: joining together the negative part from step e) and the positive part of the standardised test body from a) and assessing the fit. A further formulation of the step (with swapped parts) is: joining together the positive part from step e) and the negative part of the standardised test body from a) and assessing the fit.

Herein, what is denoted by fit is the dimensional relation between the two parts that are to fit together. These parts at the joining location have the same contour, once as the inner shape (positive part) and once as an outer shape (negative part). The dimensions of both contours have the same nominal dimension. What is different is the actual dimension that arises on manufacture. Its deviation from the nominal dimension is detected in step f) and is compared to predefined tolerances.

Step f) preferably includes the following part-steps:
f).1 joining into one another or putting together the produced negative part or positive part from step e) and the positive part or the negative part of the standardises test body from step a)
f).2 acquiring and preferably also measuring possible distances, free spaces or gaps between the two parts from f).1 that have been joined into one another or put together.
f).3 comparing the distances, free spaces or gaps that are acquired or measured in f).2 with predefined tolerance ranges.

A preferred method of the invention therefore relates to: a method for calibrating a data acquisition device and a peripheral device including the following steps:
a) providing a standardised test body, which consists of a positive part and a negative part, and a standardised digital data set of the three-dimensional data of the negative part of the test body as a shape master;
b) acquiring three dimensional data of the positive part of the standardised test body from a) with the data acquisition device to be calibrated and generating a corresponding digital data set of the positive part of the standardised test body,
c) importing the digital data set from b) into CAD software and loading the standardised digital data set from a);
d) designing a negative part with the help of a digital data set from b), the standardised digital data set from a) and the CAD software from c);
e) producing the negative part amid the use of the design from d) and of the peripheral device to be calibrated;
f).1 joining into one another or putting together the produced negative part from step e) and the positive part of the standardised test body from a);
f).2 acquiring and measuring possible distances, free spaces or gaps between the parts from f).1; and
f).3 comparing the distances, free spaces or gaps which are acquired or measured in f).2 with predefined tolerance ranges.

This fit should correspond to the predefined demands with regard to the precision and stability. Deviations can be measured and registered. If the measured deviations lie within predefined tolerance ranges, then the calibration is complete. Given an incorrect or inadequate fitting accuracy or fit, the user has the possibility of optimising the end result by way of changes at the settings of the devices or in the design software (setting for fit, fashioning of the edge, fashioning of the gap etc.) within the framework of a repetition of steps c) to f) of the methods according to the invention. By way of the repeated production of new workpieces, he can adjust the settings of the devices such that the predefined tolerance ranges are no longer exceeded and herewith a predictable precision of his future products arises.

A further embodiment of the methods according to the invention hence relates to the parameter settings of the CAD software and the parameters of the peripheral devices being adjusted until the desired fitting accuracy between the standardised test body part and the manufactured counter-piece is achieved. Step h) thus relates to a repetition of the steps c) to f) of the methods according to the invention, wherein an adjustment of the parameters of the CAD software and/or of the parameters of the peripheral device takes place until the fitting accuracy lies within predefined tolerances. A method for calibration according to the invention is then completed, and the device pair of the data acquisition device and the peripheral device is calibrated. The actual production can now begin with the settings and/or parameters that are determined in the calibration method.

Not all production processes are equally prone to inaccuracies and for this reason the tolerance ranges for the fitting accuracy can be defined differently by the user depending on the workpiece to be produced. Dental splints and surgical auxiliary templates for bringing implants into the oral cavity accept, e.g., greater tolerances than a stationary tooth replacement that is to be screwed or cemented on implants in the mouth. The same applies especially for work on implants (artificial dental roots of titanium or zircon), which demand an even more precise production of the workpieces since in contrast to the natural anatomical structures they are fixedly anchored in the bone and provide no room for play due to their mechanical strength, in order to compensate possible inaccuracies. Fit inaccuracies under such conditions biologically and biomechanically have a particularly problematic effect. For this reason, the steps c) to f) of the methods according to the invention should be possibly repeated, until the fitting accuracy between the workpiece (whichever, the positive part or negative part) from step e) and the counter-piece of the standardised test body lies in the region of predefined tolerances, which means until the two counter-pieces match one another in a sufficiently precise manner.

Generally, in the field of dental medicine, the scanned anatomical structures of the oral situation should be reproduced as exactly as possible. With regard to current processes, a tolerance of 50 to 100 microns is often accepted. With the methods which are known in the state of the art, a tolerance range with deviations of ±50-100 microns has dominated as a dental industry standard. Today, the manufacturers of peripheral devices specify tolerances of 100 microns as a specification for the precision of their devices. Earlier—in the analogue workflow (handcraft)—it was 50 microns. For this reason, a tolerance range of 50 micrometers or less is also sought in the digital workflow. The fact that the tolerances in digital workflow at present do not lie below 0.1 mm, according to research on which the present invention is based, amongst other things is also due to the absent calibration of the device pairs. A calibration of a data acquisition device and a peripheral device can improve the fitting accuracy of the workpieces to be produced to such an extent that tolerance ranges of 0.05 and smaller are possible. In the context of the methods according to the invention, it is therefore preferable if the predefined tolerance ranges are ±0.1 mm, further preferably ±0.05 mm and particularly preferably ±0.01 mm.

The calibration by way of one of the methods according to the invention can be repeated arbitrarily often. A calibration of a certain device pair of the data acquisition device and the peripheral device can always become necessary again and again. The methods according to the invention can be repeated at any time, in order to examine or newly adjust a device pair and the parameters which match this. It is recommended to always apply such an examination or repetition if something fundamental has changed. An examination of the internal production chain by way of the methods according to the invention is therefore to be desired, if
a new scanner or new optics in the scanner are applied,
a new peripheral device or an important component in a newly calibrated peripheral device has been exchanged, e.g. a new milling set has been applied,
if concerning devices which have remained the same, different or new materials are applied in the production.

In the case of a breakage or other damage of the standardised test body, new test bodies are to be procured. In such a case, a new calibration of the devices should likewise take place.

A further aspect of the invention relates to test bodies that are suitable for carrying out the methods according to the invention for calibrating a data acquisition device and a peripheral device. Furthermore, the invention encompasses the methods according to the invention for calibration, wherein at least one of the test bodies, which are described hereinafter, is applied.

An embodiment of the present invention relates to test bodies that are characterised in that the test body consists of a positive part (a male part) and of a negative part (a female part), and that the positive part and the negative part engage into one another such that at least one horizontal contact surface, a Morse taper and an oblique contact surface that tapers to the surface (preferably the outer surface) of the test body arise. These test bodies should preferably be suitable for calibrating a data acquisition device and a peripheral device. The test bodies according to the invention are particularly suitable for use in the methods according to the invention for calibrating a data acquisition device and a peripheral device.

The term “Morse taper” as is used herein describes that one of the two counter-pieces of the test body includes a cone which corresponds to the standardised shape of a tool taper for clamping tools in the tool receiver of a machine tool (here a hollow cone in the corresponding counter-piece). A self-locking, thus a resistance caused by friction, against a slippage or a twisting of the counter-pieces that bear on one another or lie in one another, exists between the hollow cone of the positive part and the cone of the negative part, which clamps therein (or vice versa). The self-locking is herein influenced by the angle of inclination, the surface roughness of the contact surfaces, the material pairing and the heating. With regard to the structure that is described as a Morse taper, concerning one of the counter-pieces of the test body, it is a cone or truncated cone and in the corresponding counter-piece it is an inner cone, into which the cone or truncated cone fits such that a self-locking is present under normal conditions (room temperature, no lubricant). In the case that the Morse taper is designed as a truncated cone, it forms a horizontal contact surface (horizontal to the stand surface) which corresponds to the cover surface of the truncated cone. The lateral surface of a Morse taper connects onto this. Then a horizontal contact surface that is surrounded by the oblique surface of an inner cone is then likewise located in the counter-piece.

The contact surface which is denoted as a “horizontal contact surface” is to be horizontal to the stand surface or to the base body of the positive or negative part. The oblique contact surface, which tapers to the surface of the test body, is a contact surface between the positive part and the negative part, which is not horizontal to the stand surface. It has an inclination or gradient in relation to the stand surface. This means that an imagined extension of the oblique contact surface intersects the stand surface of the test body. The oblique contact surface preferably has a gradient angle of greater than 5 degrees and smaller than 45 degrees and particularly preferably between 10 and 35 degrees. The fact that the contact surface tapers up to the surface of the test body means that the contact surface ends at the surface of the test body (consisting of the joined together positive part and negative part). Herein, it is preferably the case of an outer surface of the test body, and not of a surface that is located in the channel. The contact surface is therefore preferably an outwardly obliquely running surface in the post of the test body. The oblique contact surface, which reaches up to the surface of the test body, preferably ends at least in one of the two parts of the test body at its lateral surface or at its periphery of the cross section. In other words, the oblique contact surface forms a common edge with the periphery or the lateral surface of at least one of the two parts of the test body. A preferred embodiment relates to test bodies according to the invention which are characterised in that the oblique contact surface, which reaches up to the surface of the test body, ends at the periphery of the test body (consisting of the joined-together positive part and negative part) or its lateral surface.

It is preferable for the two counter-pieces of the test body, thus the negative part and the positive part to each include a main body and at least one post, wherein they preferably engage into one another by way of the at least one post. The contact surface of the counter-pieces of the test bodies according to the invention thus preferably lies in at least one post. The surface or the surfaces of the posts which lie at that side that is away from the base body thus forms the contact surfaces (face side). If several posts are present, then the counter-pieces preferably engage into one another within all posts. Concerning embodiments with several posts, the base body can also be designed as a connector or connection piece. In this case, the posts do not stand on the base body but the base body is arranged between at least two posts, thus it connects these.

A preferred embodiment includes test bodies according to the invention that are characterised in that they include at least two posts, which have an identical geometry. The posts can have an arbitrary cross section. The cross section can, e.g., be square, rectangular, rhomboid, hexagonal, octagonal, ellipsoidal or triangular. However, it is preferable for the cross section of the at least one post and as all further posts to be round. The diameter of a post preferably lies between 2 and 8 mm. The distance between 2 posts is preferably between 1 and 12 mm large. The preferred height of a post is between 3 and 15 mm. The base body of the test body can be shaped out in an arbitrary manner. It can be, e.g., a cuboid, a cube, a rhomboid, a prism, a wedge, a cylinder or a circular cylinder. The base body is preferably a cuboid or a cube. The cube preferably has an edge length of 5 to 30 mm and the cuboid preferably has a height of 1 to 15 mm, a width of 5 to 30 mm and a depth of 1 to 30 mm. Concerning embodiments with at least two posts, it is further preferable for the contact surfaces of the posts to lie at different heights, the positive part and the negative part therefore engage into one another at different heights (for example, differently elevated, horizontal contact surfaces). This means that the posts of a positive part have different heights and the posts of the negative part accordingly also, wherein a lower (shorter) post in the negative part corresponds to a high post in the positive part.

A positive part (male part) and a negative part (female part) each form a unit, specifically the test body according to the invention. The positive part and the negative part are counter-pieces, which are shaped out such that they fit with one another with a high precision, which means they engage into one another. If the two counter-pieces are joined together such that they engage into one another, then possibly occurring gaps between the surfaces of the counter-pieces (positive part and negative part of the test body) should not be greater than 0.1 mm, preferably not greater than 0.5 mm and in particular not greater than 0.05 mm. This in particular relates to the gap width but also independently of this to the gap length. The test bodies are preferably milled from blanks.

The test bodies of various product series can vary. It is not therefore guaranteed that test bodies or their counter-pieces from different production series are always compatible. For this reason they should be provided with batch numbers. It should be taken care that the respective device pair is calibrated with a test body of the same batch number, or with counter-pieces of a test body. If a test body breaks, then it is always both test body parts or the applied pair of test bodies of the respective device pair that need to be exchanged.

It is therefore preferable for the positive part and the negative part of a test body according to the invention to have been manufactured in a common manufacturing process,

The test bodies according to the invention preferably consist of a shape-stable material. The material of the test body should be selected such that as little as possible permanent deformation can take placed due to an external loading. It should therefore have a low deformability. In particular, a low plastic deformability is desirable. However, the elasticity should also be low. It is generally brittle materials which are suitable. It is preferable if the material of the test bodies according to the invention is selected from the group consisting of: glass, hard rock (high wear-resistance) such as granites, tonalities, or basalts, metal alloys, such as Cr—Co alloys, ceramic, such as zirconium dioxide or lithium disilicate (high-strength glass ceramic), ceramic composite, PMMA, PEEK and polycarbonate. Herein, particularly preferable are metal alloys such as Cr—Co alloys, ceramic such as zirconium dioxide or lithium disilicate (high-strength glass ceramic) and PEEK.

Inherent of the manufacture, some of the produced workpieces, depending on the device to be calibrated and the applied material (e.g. grain size), have no ideal corners or angles. For this reason, preferred test bodies can include rounded or cambered corners, edges and/or angles. Herein, a radius of <0.5 mm is preferable and even more preferred is a radius of ≤0.1 mm. Alternatively, one can also predefine the tolerance ranges accordingly. The angles and edges, which are formed when horizontal, oblique or slanted planes or surfaces come together, should preferably have a rounding with a radius of ≤0.2 mm. These roundings can be adapted to the geometry of common CAD millers and the grain sizes of the material of additive methods.

Another embodiment of the present invention relates to test bodies according to the invention, which are characterised in that the positive part and the negative part of the test body have been manufactured from different materials. By way of this, one can accommodate the future production that is to take place by way of the calibrated devices. It can be advantageous if the test bodies are manufactured from the materials, from which the future products are also manufactured.

In a further embodiment of the test body according to the invention, the test body includes at least one channel. The channel is preferably located around the middle point of the test body or of a post of the test body. Furthermore, it is preferable for the Morse taper to be arranged concentrically around the canal. It is preferable for the at least one channel to permit the insertion of a test pin into the test body of the negative part and positive part. At least one channel should be arranged such that a test pin can be inserted into the positive part as well as into the negative part, or that a channel results from the two counter-pieces after unifying the two counter-pieces of the test body. The insertion of a test pin permits the setting and adjustment of hole tolerances. The at least one channel is preferably 1 to 7 mm long or deep and preferably has a diameter of 1 to 4 mm.

A preferred embodiment of the present invention furthermore relates to test bodies, which are characterised in that the at least one channel in its course includes a step in the inside. This step preferably forms a contact, which runs horizontally to the standing surface of the test body. This means that the step forms a 90 degree angle. The step, however, can indeed also have different angles. Preferred angles are ≥90 degrees. Particularly preferable are angles of 90 degrees, 135 degrees, 150 degrees and 160 degrees. According to the invention, steps which have an angle of 90 degrees are very particular preferred. The diameter of the channel is reduced by the step preferably by 0.5-3 mm

A further aspect of the present invention relates to a set consisting of a test body according to the invention and at least one test pin, which is insertable into the at least one channel of the test body. It is preferable for the outer diameter of the test pin to be only insignificantly smaller that the inner diameter of the channel in the test body. The test pin accordingly also replicates a possibly present step in the channel. The test pin is generally designed such that it can be inserted into the channel of the test body in an exactly fitting manner. The sets according to the invention can furthermore include several test pins, which is particularly helpful if the test body includes channels with a different course (e.g., different diameters or differently formed steps).

The sets according to the invention can furthermore additionally include at least one standardised digital data set of the positive part of the test body and at least one standardised digital data set of the negative part of the test body.

A further aspect of the invention relates to a computer-implemented method for planning prosthetic workpieces including the following steps:
I) providing patient-related data, which relate to a tooth to be restored or replaced, in digital or digitalised form:
II) providing shape masters in the form of digital data;
III) providing biological and anatomical average values with regard to the tooth to be restored or replaced;
IV) computing a digital data set which can serve as a model for a CAD miller or for a device for the additive manufacture of a prosthetic workpiece, wherein the data from II) is personalised and optimised with the help of the data from I) and III).

A reconstruction of the absent part of the tooth needing repair or for the manufacture of a tooth replacement is based on the data set that is determined by the computation and optimisation in step IV). A physical tooth replacement part or the physical tooth restoration is manufactured by way of a machine that is controlled in accordance with the data set that is obtained in step IV). A further aspect of the invention therefore relates to a computer-implemented method for the manufacture of prosthetic workpieces including the above steps I)-IV). The prosthetic workpieces which are to be planned or manufactured include the group consisting of: tooth replacement parts, attachment parts (pin attachments, implant attachments or abutment), implant crowns, webs, dental crowns, splints, drilling templates and bridges. The present invention further also relates to software (design tool) that is designed for carrying out the previously described method.

The computer-implemented methods can further include at least one of the following steps sub-steps:
manual changing of individual parameters or dimensions with an automatic adaptation of the remaining parameter or dimensions.
   During the manual correction (at the computer screen) of a sub-structure of the prosthetic workpiece, the remaining structures are adapted in a purely numeric manner. This is based on the stored data from II) and III). The aim is to always permit the formation of a total structure which is biologically or anatomical meaningful and which is adapted to the patient.
extrapolation of the crown structure in the sub-mucosal region up to the crown edge
   This can be a sub-step of step IV). The extrapolation is based amongst other things on the individual tooth position and the contour of the emergence line of the soft tissue and takes into account stored average dimensions of the tooth which is to be replaced or restored by the planned prosthetic workpiece. Furthermore, the position and extension of contact point areas and contact regions of intermediate members can be taken into account.
determining the surface nature of certain areas.

Herein, the roughness of at least some areas and/or microstructures can be determined. By way of this, one succeeds in ensuring an optimised contact of the workpieces to the surrounding tissue after the insertion in the patient.

The patient-related data can be produced by way of a scanner (e.g., oral scanner), photo apparatus (digital pictures of the face and lip view of the patient), digital computer tomography or digital volume tomography (information on bony structures). The data relates amongst other things to the dimensions of adjacent toothing, the mirroring of the teeth on the opposite side, the course of the occlusal line in the counter-jaw and the dimensions of the bone structures and of the soft tissue.

The shape masters are based on a data bank of natural tooth shapes, obtainable implants, auxiliary parts and common crown shapes and serve as a model for creating the design of the workpieces. Starting from the digital picture of the planned workpiece, the implant position and implant inclination can be determined, and the design of the workpiece that matches this can be computed and digitally represented.

The principles for the design shaping of the workpieces are stored in the software and can already be activated in the stage of the planning. The program can compute various design components and automatically put them together into a workpiece with the anatomical shape by way of the rules concerning the anatomy, biology and biomechanics that are stored in it, and therefore permits the combination of optimal fitting and optimal shaping. Furthermore, it can have a tool which can set the surface nature (roughness, microstructure) of certain areas. Herewith, one succeeds in designing the surfaces of the workpieces such that they achieve the best possible effect given their contact with the biological surroundings.

The biological and anatomical average values relate, e.g., to the course and the contour of the enamel cap at cementum-enamel junction, the biological width (average values for the soft tissue compartment consisting of the three areas: sulcus, epithelial attachment and connective tissue attachment), biomechanical values of teeth and tooth positions as well as the materials which are used for the manufacture of the workpieces, and anatomical features such as soft-tissue contours, axis inclinations, crown lengths and widths, the position and extension of the contact point areas or the contact region of intermediate members.

The computer-implemented methods according to the invention are particularly suitable for optimally designing the transition of a superstructure or an attachment part to the implant. The methods are particularly suitable for determining important implant parameters such as position, inclination, diameter, length, type (TL versus BL) and material (titanium, titanium-zircon, zirconia) of the implant(s) to be incorporated, such that one takes into account the jaw anatomy as well as the planned superstructure with regard to prognosis, function and aesthetics, in an optimal manner. The attachment part of the implant (inasmuch as exists), also that region of the implant that is configured to stay on the other side of the jawbone and to be surrounded by soft tissue can be optimally matched to the patient. For this, the anatomy of the jaw, the soft tissue height and soft tissue counter and the shape masters which are available for selection for the implant attachments are taken into account. The usefulness of an optimised shape and surface design of abutments and crowns at the transition to the implant is large, in particular due to the fact that on account of this, one prevents an implant attachment having to be manually reduced in its material thickness after its production. It is above also with pushed-over crowns, which are provided with a connection portion in the shape of a barrel ring (as is described in WO 2018/215616), that it is important for the material thicknesses which are specified in the design to no longer be fallen short of for reasons of stability. Only by way of such can a guarantee of the mechanical stability be ensured.

Furthermore, a surface structure and surface roughness that are optimal for the soft tissue can be determined and implemented on manufacture. If this structure were to be manually machined secondarily, the workpiece would possibly lose some of the characteristics, which are planned on the computer. In this context, a subsequent deposition of ceramic for the improved contouring by the dental technician should be prevented, since deposited ceramic is porous and does not provide the optimal surface for a best possible integration of soft tissue.

### BRIEF DESCRIPTION OF THE DRAWINGS

The test bodies according to the invention are further described in more detail by way of the subsequent drawings, wherein:

FIG. 1A: shows a positive part (2a) of a test body according to the invention, in a longitudinal section.

FIG. 1B: shows a further positive part (2b) of a test body according to the invention, in a longitudinal section.

FIG. 2A: shows a positive part (2a) of FIG. 1A, which has been joined together with a matching negative part (1a) and together forms a test body according to the invention.

FIG. 2B: shows the poitive part (2b) of FIG. 1B, which has been joined together with a matching negative part (1b) and together forms a test body according to the invention.

FIG. 3A: shows the test body according to the invention of FIG. 2A, into which a test pin (8) has been inserted.

FIG. 3B: shows the test body according to the invention of FIG. 2B, into which a test pin (8) has been inserted.

FIG. 4: shows a positive part (2) of a test body according to the invention, which includes two posts (9a, 9b), in a longitudinal section.

FIG. 5: shows the positive part (2) of FIG. 4, which has been joined together with a matching negative part (1) and together forms a test body according to the invention.

FIG. 6: shows the test body according to the invention of FIG. 5, into which 2 test pins (8) have been inserted.

FIG. 7A: a shows a negative part (1, above) in a lower view, and a positive part (2, below) of a test body according to the invention.

FIG. 7B: shows the test body of FIG. 7A after the engagement of the negative part (1) and the positive part (2) into one another, in a view from above.

FIG. 8: shows a positive part (2) with three posts (9a, 9b and 9c) in a view from above.

FIG. 9: shows a further positive part (2) with three posts (9a, 9b and 9c) in a view from above.

FIG. 10: shows 2 possible post variations (9a, 9b), which can occur with the test bodies according to the invention with at least 3 posts.

FIG. 11: shows a further positive part (2) with three posts (9a, 9b and 9c) in a view from above.

FIG. 12: shows a positive part (2) with four posts (9a, 9b, 9c and 9d) in a view from above.

FIG. 13: shows a positive part (2) with four posts (9a, 9b, 9c and 9d) in a view from above, wherein the arrangement of the posts varies in comparison with FIG. 12.

FIG. 14: shows a test body according to the invention (positive part and negative part) with three posts (9a, 9b and 9c) in a view from above.

FIG. 15: shows a further test body according to the invention (positive part 2 and negative part 1) with three posts (9a, 9b and 9c) in a view from above, wherein the arrangement of the posts (9a, 9b and 9c) and the shape of the base body of the negative part 1 vary in comparison with FIG. 14.

FIG. 16: shows a test body according to the invention (positive part 2 and negative part 1) with four posts (9a, 9b, 9c, and 9c) in a view from above.

FIG. 17: shows a further test body according to the invention (positive part 2 and negative part 1) with four posts (9a, 9b, 9c and 9d) in a view from above, wherein the shape of the base body of the negative part (1) varies in comparison to FIG. 16.

FIG. 18: shows three different test pins (8), which can be used in combination with the test bodies according to the invention.

FIG. 19: shows an aspect of a dental implant system, which can be optimised with the help of the computer-implemented method according to the invention.

FIG. 20: shows a further aspect of a dental implant system, which can be optimised with the help of the computer-implemented method according to the invention.

FIG. 21: shows an aspect of a dental implant system, which can be optimised with the help of the computer-implemented method according to the invention.

FIG. 22: shows an aspect of a dental implant system, which can be optimised with the help of the computer-implemented method according to the invention.

### DETAILED DESCRIPTION OF THE INVENTION

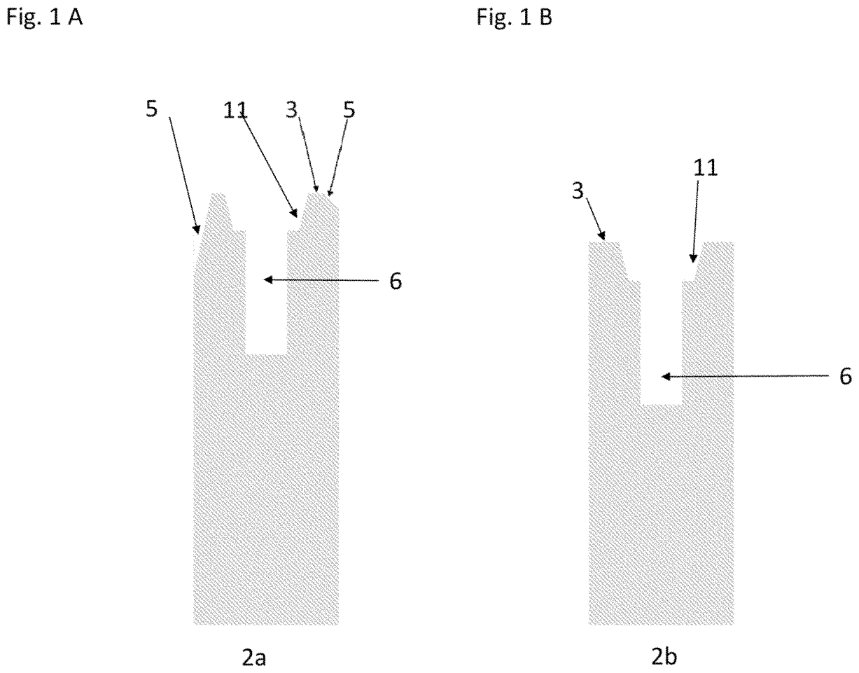

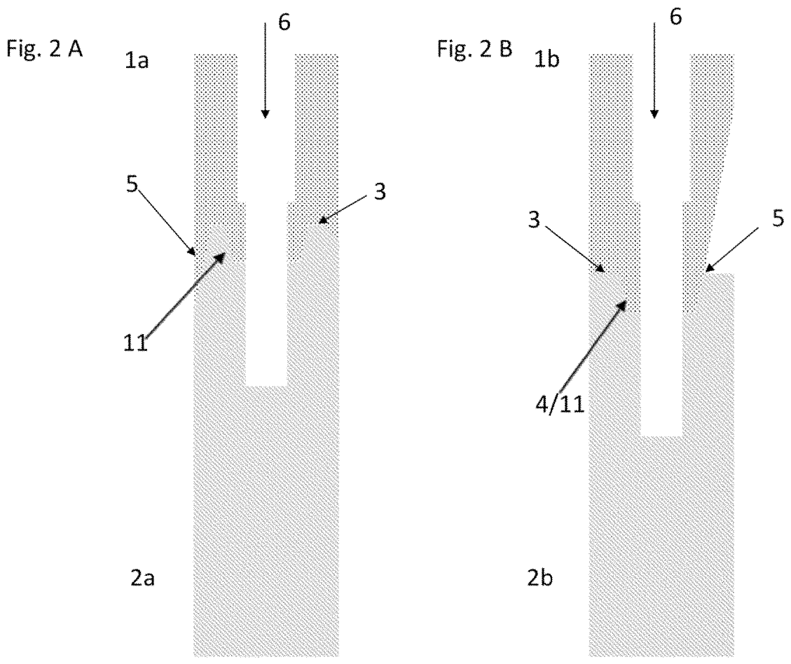

FIGS. 1A to 3B by way of two simply designed examples of a test body according to the invention show its construction as well as the most important constituents and features. As has been generally explained further above and is evident from FIG. 2, a test body according to the invention includes a positive part (2) and a negative part (1), wherein the positive part (2) and the negative part (1) at their end-faces engage into one another with their respective corresponding horizontal (3) and oblique inner (4) and/or outer (5) contact surfaces. The positive part (2a) as is shown in FIG. 1A is essentially a column with a round cross section, wherein other cross sections are also possible, such as, e.g., oval, square, rectangular or irregular cross sections. At its upper end it includes an obliquely outwardly tapering surface (5). This is directed to a geometry as is common for dental preparations and TL implants (tissue level implants). The obliquely outwardly tapering surface (5) in the periphery abruptly changes the inclination angle. In the shown longitudinal section, this is to be recognised by way of the horizontal contact surface following differently steep sections to the outside. The positive part additionally has a Morse taper or hollow cone (11) and in the centre has a central channel (6) in the z-axis direction (analogously to a screw hole). The positive part (2b) as is shown in FIG. 1B is essentially likewise a round column. It includes a plane end-face/contact surface without a bevelling. It is adapted to the geometry as is common for step preparations and implants with butt-joint connections or head-to-head connections. The positive part (2b) likewise has a hollow cone (11) and a channel (6) that runs in the centre.

FIGS. 2A and 2B in a longitudinal section show the positive parts (2a, 2b) from FIGS. 1A and 2B together with matching negative parts (1a, 1b). A positive part and the associated negative part together each form a test body according to the invention. As is evident from FIGS. 2A and 2B, the positive parts (2a, 2b) and the negative parts (1a, 1b) are designed such that they engage into one another. It is preferable for the positive parts (2a, 2b) and the negative parts (1a, 1b) to engage into one another in such an exactly fitting manner that the contact surfaces mate without forming a gap. Depending on the manufacture and the material from which the test bodies are manufactured, this is not always possible. Possibly occurring gaps between the contact surfaces of the counter-pieces (positive part and negative part of the test body), however, should preferably not be larger than 0.1 mm, further preferably not greater than 0.5 mm and in particular not larger than 0.05 mm.

Both counter-pieces of the test bodies according to FIGS. 2A and 2B, thus the positive part (2a, 2b) and the negative part (1a, 1b) have a section of the outer surface that fit into one another, said section running horizontally to the stand surface of the test body, so that a horizontal contact surface (3) arises on joining together both counter-pieces. The test body according to the invention of FIG. 2A further has two obliquely running contact surfaces (5) that both run up to the outer surface of the test body. These two oblique surfaces have a different angle of inclination. The test body according to the invention of FIG. 2B has an obliquely running contact surface (5), which runs up to the surface of the test body and simultaneously forms part of the Morse taper.

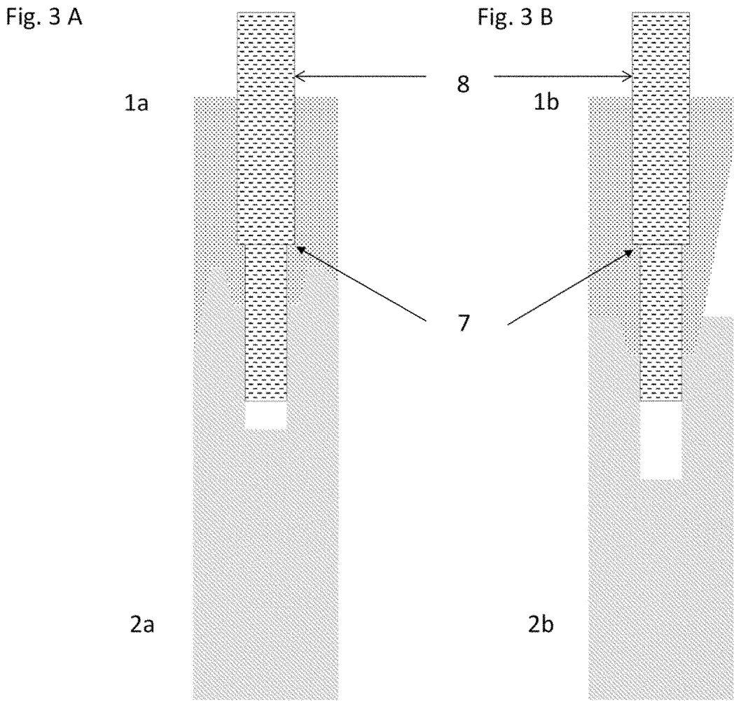

The negative parts (1a, 1b) on the surface that engages into the contact surface of the corresponding positive part include a Morse taper, which fits into the Morse taper of the positive part (2a or 2b) such that a self-locking occurs. What is significant for this is the inclination angle, but the surface roughness and the temperature also have an influence. The Morse taper or inner cone (11) and the oblique contact surface, which tapers up to the surface of the test body (5), permit an assessment of the peripheral accuracy and the shrinkage compensation. The test body according to FIGS. 2A and 2B or according to FIGS. 3A and 3B include a central channel (6) that is led through the respective negative part (1a, 1b) and projects into the positive part (2a, 2b). The channel has a step (7) or a shoulder in its course. The diameter of the channel reduces at this step (7). The channel preferably has a round cross section but can also be oval or polygonal.

In FIGS. 3A and 3B, the test bodies of FIGS. 2A and 2B are shown with an inserted test pin (8). The test pin (8) has an outer diameter, which is only insignificantly smaller that the inner diameter of the channel (6). The test pin thus likewise fits into the test body in an as exactly fitting as possible manner. Concerning the embodiment according to FIGS. 3A and 3B, the channel each includes a step (7). Consequently, the test pin (8) should also have a step (running oppositely), at which the diameter of the cross section of the test pin (8) reduces in accordance with the diameter of the channel (6) in the test body. The shown step forms a 90° angle (herein it is always specified as the angle in degrees to the horizontal contact surface). The insertion of a test pin into the test bodies according to the invention permits the setting and adjusting of hole tolerances. A step (7) in the inside of the channel (6) and the matching pin construction permits the so-called Sheffield test, which serves for testing the correct seating of the inner configuration.

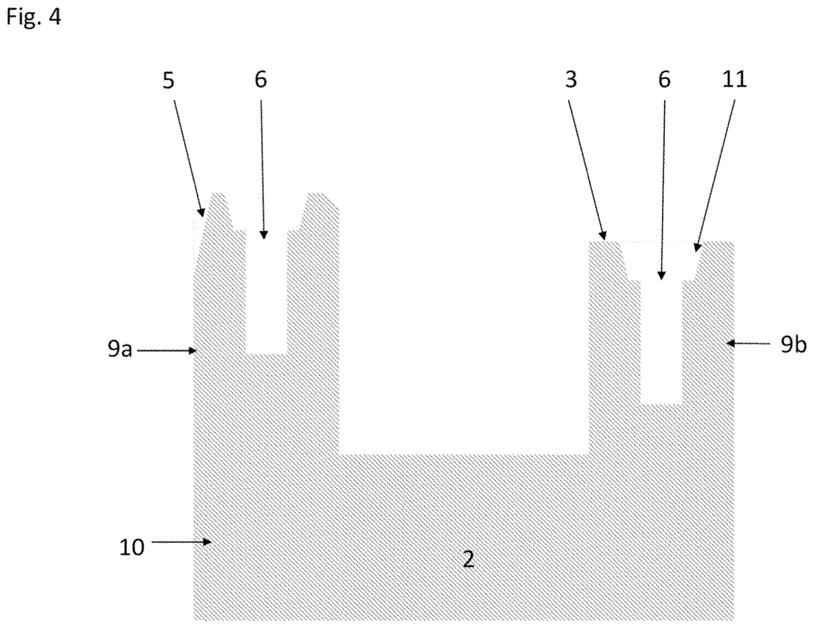

FIGS. 4 to 6 show a preferred embodiment of a test body according to the invention as longitudinal sections. The same elements are provided with the same reference numerals as in the previous Figures. The positive part (2), which is shown in FIG. 4, has a cuboid base body (10) and two posts (9a, 9b). These posts can be designed as columns with an arbitrary cross section. In a preferred embodiment, both columns have a round cross section. The contact surface of the counter-pieces (positive part and negative part) is formed by the posts. The positive part (2) shown in FIG. 4 simulates two bridge posts whose geometry is adapted to the common geometries of implant posts and natural posts in the dental field. The distance between the two posts (9a, 9b) is therefore preferably between 5 and 7 mm and corresponds roughly to the width of a premolar. The two posts (9a, 9b) are aligned parallel to one another (parallel, vertical axes). A central channel (6) runs in each post. The post (9a), which is at the left in the picture, in the periphery changes in the design of its contact surfaces or the contact surface with the counter-piece. This is possible in all embodiments of the test bodies according to the invention. In the shown longitudinal section, this can be recognised in that differently steep sections follow after the horizontal contact surface. A change of the gradient of the bevelled contact surface is preferably designed as a step which occurs at two locations. Herein, these steps in cross section can be arranged directly oppositely (lie on a straight line through the circular cross section) so that after 180° a change between a steeper, longer bevelling up to a shallower, shorter bevelling occurs. The bevelled contact surface can however also be designed with a continuously changing gradient. Furthermore, it can also run in the form of a helix or spiral around the column. Furthermore, the post (9a) includes a horizontal contact surface (3) and an inner cone (1).

The post (9b), which is arranged at the right, includes a plane end-face without a bevelling (horizontal contact surface 3) and likewise has a hollow cone (11) and a channel (6) which runs in the centre. The posts (9a and 9b) of the positive part (2) are differently high. This is selected since the implant shoulders in the mouth very often come to lie at different levels. These level differences represent difficulties with regard to an optimal fitting which can be tested with the test bodies according to the invention.

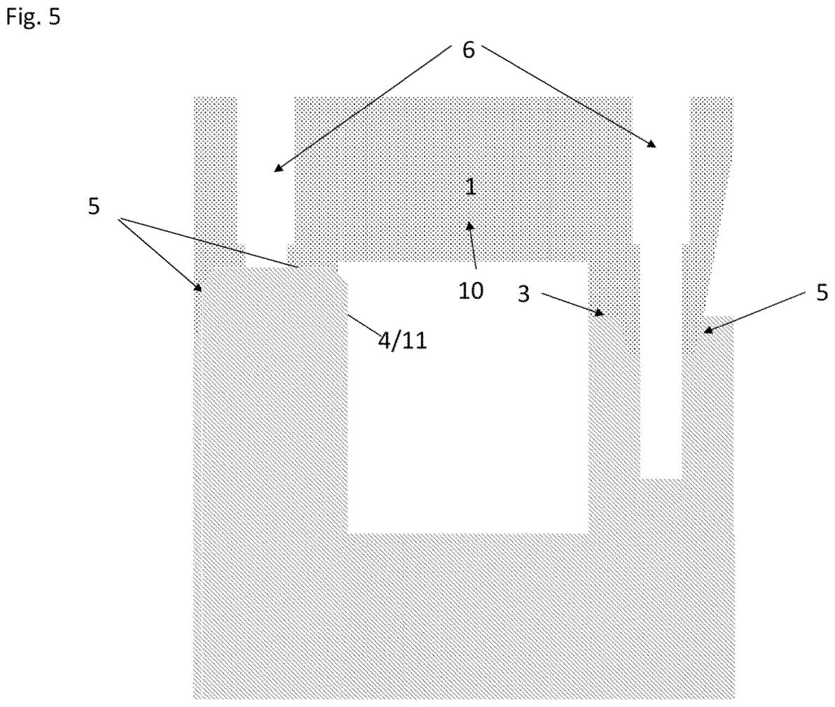

The negative part (1) in FIG. 5 simulates a 3-part bridge, which is received by the positive part (2) in an exactly fitting manner. The base body (10) of the negative part, which here is designed as a connector, has the shape of a cuboid which is arranged between the two posts. The posts are columns whose cross section is preferably round. The contact surfaces of the negative part according to the invention are designed such that they have a shape that corresponds to the contact surfaces of the positive part. They preferably assume a positive connection with the contact surfaces of the positive part. The contact surfaces form the contact surface of the counter-pieces of the test body. The height of the base body of the negative part (1) is preferably approx. 4 mm and is preferably approx. 2.25 mm wide. The cross section of this preferred embodiment accordingly roughly corresponds to the recommendations for the correct dimensioning of bridge connectors given 3-part bridges. The combination of the preferred post distance and the preferred dimensions of the connection zone in the negative part (1) permits the testing of the torsional stiffness of a test body with the sintering process and its possible shape bending, which can likewise be observed in the Z axis (bending occlusally) with the sintering process.

The total height of the negative part (1) is preferably between 4 and 8 mm and herewith simulates a clinically common material thickness. It gives the test body the necessary strength, which renders the setting of the correct cement gap well testable.

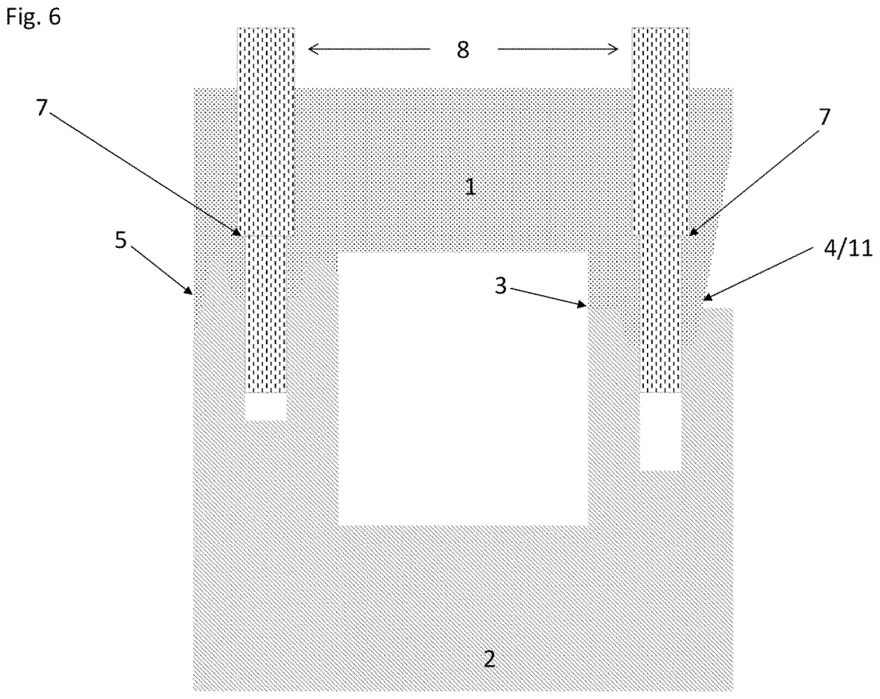

In FIG. 6, the test body of FIG. 5 is shown with two inserted test pins (8). Each of the two test pins (8) has an outer diameter that is only insignificantly smaller that the inner diameter of the respective channel (6) in the test body.

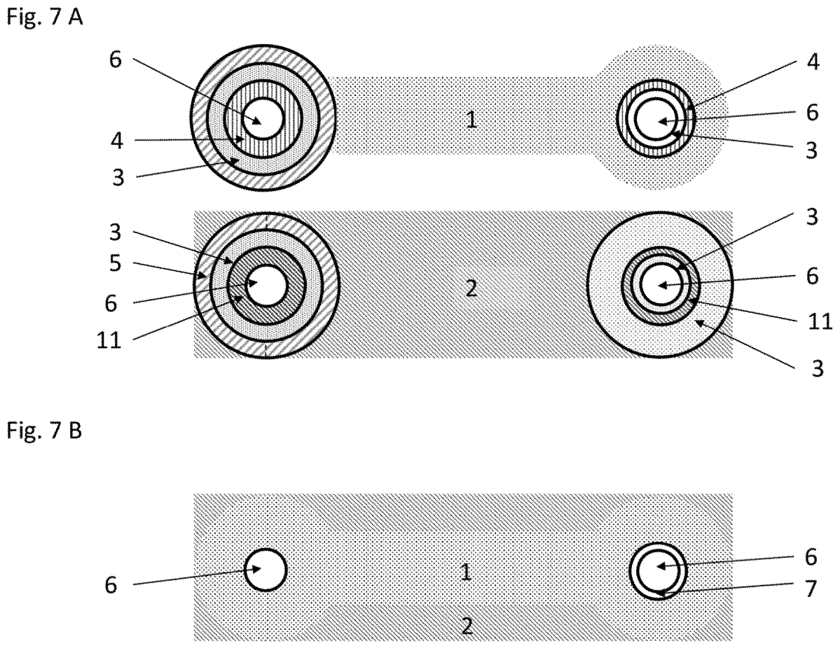

A negative part (1, above) in a lower view and a positive part (2, bottom) of a test body according to the invention are shown in a plan view in FIG. 7A. The lower view of the negative part (1) considers the negative part from below, inasmuch as one uses the arrangement in the test body as a measure. FIG. 7A therefore for both parts of a test body shows the contact surfaces, which correspond and which come to lie on one another in the test body and are accordingly located in the inside of the joined-together test body. A channel (6) is to be seen centrally in each of the two round posts of the negative part (1). A Morse taper (4) directly surrounds this channel in both posts. In turn, a horizontal contact surface (3) connects onto the lateral surface of the Morse taper. In the post (9b), the lateral surface of the Morse taper is surrounded by half of its periphery by a horizontal contact surface (3). On the side of the post (9b), which faces outwards, the lateral surface of the Morse taper in the negative part runs further to the outer lateral surface of the post. An oblique contact surface (5) whose bevelling reaches up to the lateral surface of the column and hence to the surface of the test body is arranged in the post (9a) to the outside. This contact surface (5) changes its inclination angle in the periphery of the column (indicated by the dashed line).

The surface of the shown positive part (2) is designed corresponding to this. A channel (6) is also to be seen in each of the two round posts of the positive part (2), said channel having the same cross section on the surface as the channel (6) in the lower view of the negative part. The lateral surface of the Morse taper (11) (concentrically) connects onto the channel (6). In both posts, the Morse taper is designed such that its oblique contact surface connects to the channel (6) in a direct manner. The lateral surface of the Morse taper (11) in both posts is surrounded by a horizontal contact surface (3). In the post (9a), which is arranged to the left in the drawing, an oblique contact surface (5) whose bevelling reaches to the outer surface of the test body is arranged in the post at the very outside. The dashed line indicates that after 180° the bevelling of this surface changes abruptly. The surface therefore has a significantly larger gradient to the outside than to the inside.

FIG. 7B shows the joined-together test body in a plan view. Apart from the negative part (1) and the positive part (2), one can see a channel (6) with a step (7) in the course, in each of the posts, wherein the step lies in the negative part. The diameter of the channel preferably reduces abruptly at this step, so that a horizontal surface is to be seen in the plan view. According to the invention, a step at which the radius of the cross section changes can be present in the course of the channel, either in the positive part or in the negative part. This step can also coincide precisely with the transition from the positive part to the negative part. In such a case, the channel of the negative part and of the positive part would have a differently large radius, wherein preferably the radius of the negative part is larger and the channel in the negative part runs in a continuous manner, so that a test pin as is shown in the drawing 6 can be inserted from the negative part into the put-together test body. The ability of the insertion of the test pin from the negative part is generally preferred in the context of the test bodies according to the invention.

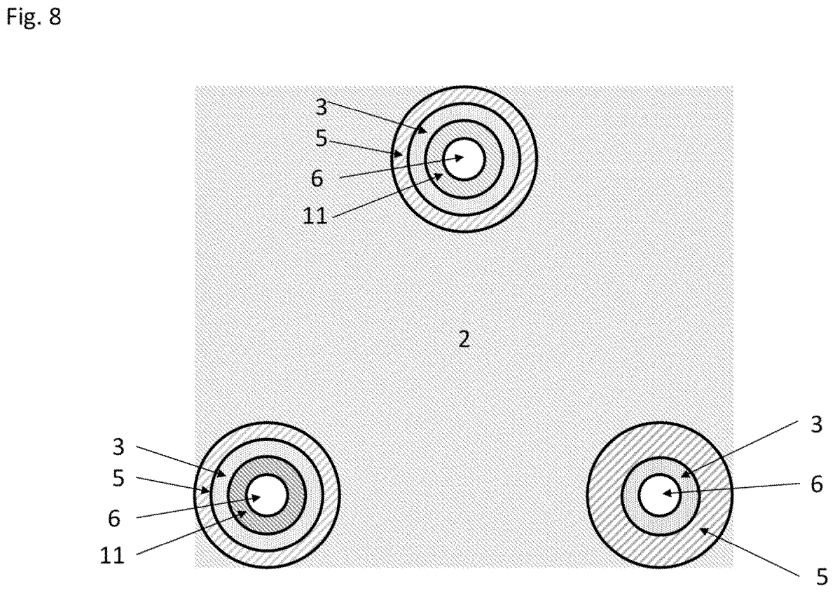

FIG. 8 shows a positive part (2) of a test body according to the invention with three round posts (9a, 9b and 9c) in a view from above. It is preferable for at least one post to have the same contact surfaces as shown in FIG. 2a or 2b in the case of embodiments with more than 2 posts. It is further preferable for at least one post to have the same contact surfaces to the negative part, as is show in FIG. 2a and a further post to have the same contact surfaces to the negative part, as is shown in FIG. 2b. The base body has a square base surface and the three posts (9a, 9b and 9c) are attached such that they form an equilateral triangle (the middle axes of the columns run through the corner points of an equilateral triangle), wherein one of the posts (9c) is arranged in the middle of one of the side surfaces of the square base surface. However, it is also possible for the posts to have an alternative arrangement. Herein, it is preferably for them to form a triangle, thus not to be arranged in a row. The posts (9a, 9b, and 9c) however can also form an asymmetrical triangular shape by way of the base body having a different base surface or the posts being arranged accordingly on the base body. The distance of the individual posts (9a, 9b and 9c) to one another is 1 mm to 12 mm independently of one another. All three shown posts (9a, 9b and 9c) include a channel (6). Two of the posts (9a and 9c) are provided with an identical structure of the contact surfaces. A Morse taper (11) or an inner oblique contact surface connects onto the channel (6). This to the outside concentrically follows a horizontal contact surface (3) and an oblique contact surface (5) whose gradient is unchanged over the complete periphery. The third post (9b) adjacent to the channel (6) shows a Morse taper (11) followed by a horizontal contact surface (5).

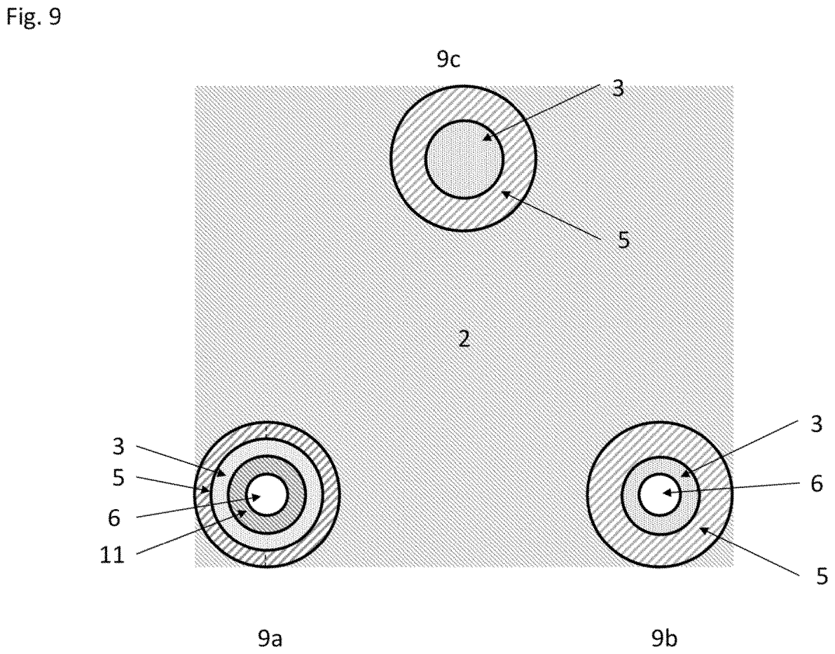

FIG. 9 shows a further positive part (2) of a test body according to the invention with three posts (9a, 9b and 9c) in a view from above. In comparison to FIG. 8, the post (9c) of this positive part (2), which is arranged at the top in the Figure, is designed without a channel (6) and centrally includes a Morse taper (11) followed by an oblique contact surface (5). The post (9a), which is shown at the bottom left corresponds to the post (9a) of FIG. 8, with the exception that the outer oblique contact surface (5) changes the inclination after 180°. The post (9b) corresponds to the post (9b) of FIG. 8.

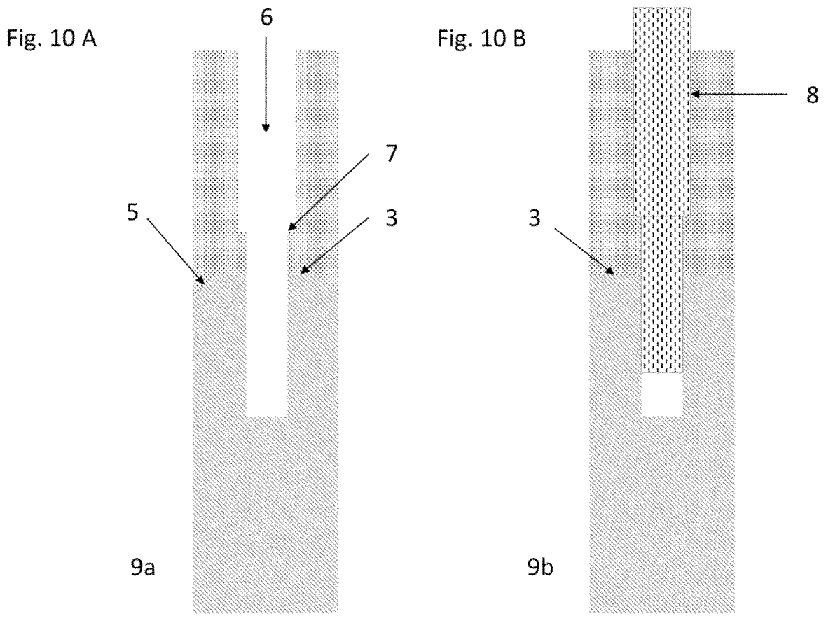

With more than two posts, the variation possibilities of the contacts surfaces or rest surfaces, which are formed by a certain post, are increased. Thus, the individual contacts surfaces of the posts can be designed in a simpler manner, wherein then however the posts vary to a greater extent within a positive or negative part of the test body. In FIG. 10, two very simply designed post variations (9a, 9b) are shown, wherein the post of the positive part as well as the corresponding post of the negative part is shown. A corresponding test pin (8) is also shown at post (9b). Both posts include a channel (6) with a step (7) for a test pin (8). In the post (9a), the step (7) is designed at an angle >90 degrees (not evident in the Figure); in the post (9b) the step (7) forms an angle of 90°. The contact surface of the post (9a) is designed obliquely (5) to the outside and horizontally inwards (2). The post (9b) has only has a horizontal contact surface (3). Theoretically, also only an oblique contact surface, inclined to the inside or outside can be present.

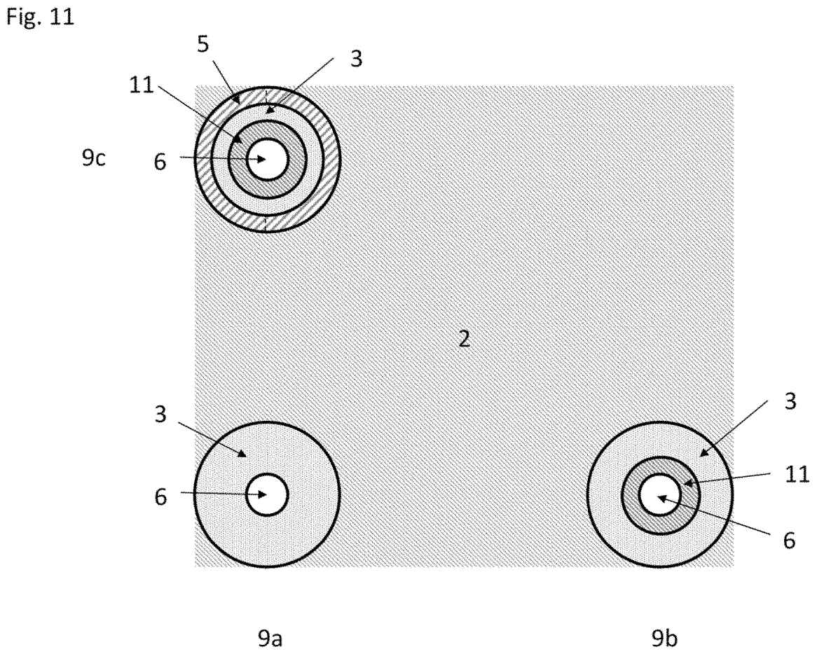

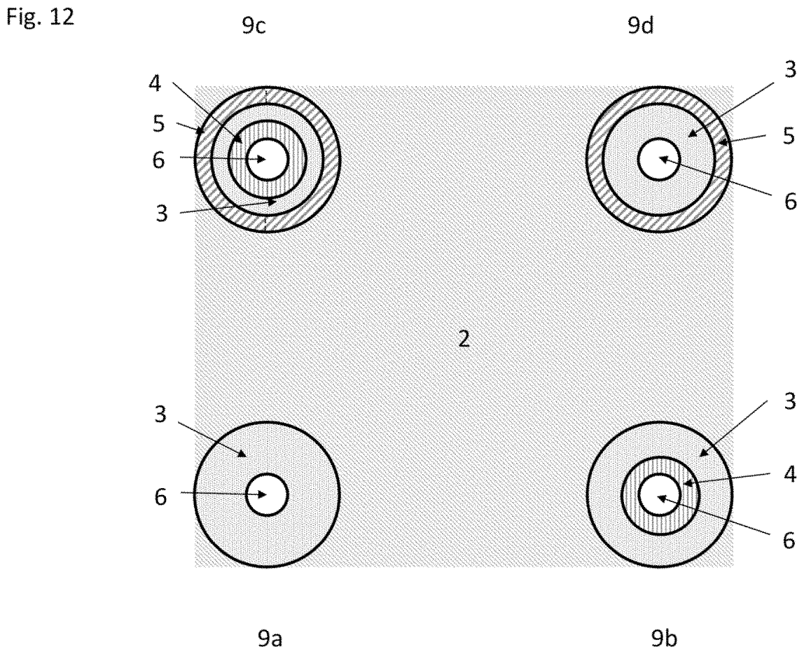

FIG. 11 likewise shows a positive part (2) of a test body according to the invention with three posts (9a, 9b and 9c) in a view from above. The posts (9a, 9b and 9c) form an isosceles triangle by way of them each being attached in each corner of a cube-shaped base body. The triangular arrangement is preferably applied such that it mirrors the shape of an anterior tooth and molar distribution, as is to be found in a jaw.

FIG. 12 shows a positive part (2) with four posts (9a, 9b, 9c and 9d) in a view from above. The posts are arranged on the base body in a rectangular shape. The distance of the individual posts is preferably between 1 and 12 mm. The posts of the positive part (2), which is shown in FIG. 12, each have different contact or rest surfaces, which are denoted by the respective reference numerals.

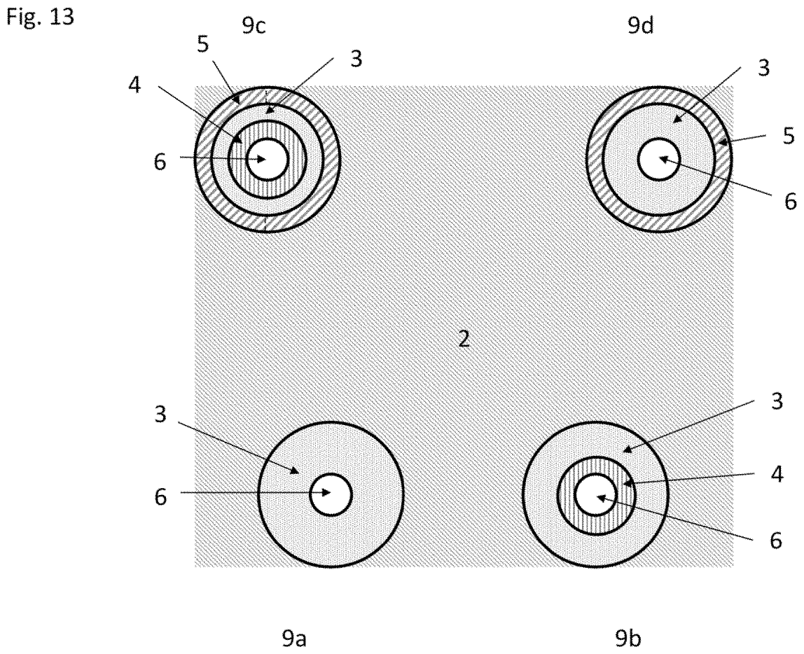

FIG. 13 shows a positive part (2) of a test body according to the invention with four posts (9a, 9b, 9c and 9d) in a view from above, wherein the arrangement of the posts varies when compared to FIG. 12. The shown arrangement corresponds to a trapezium. Basically, the arrangement of the posts is however arbitrary. It is basically preferable for at least one surface of each post to have a corresponding contact surface in the corresponding negative part. The arrangement of the posts shown herein corresponds roughly to an arrangement as often occurs in one of the jaw halves and in the dental-medical daily routine corresponds largely to a set up in a dental arch. This arrangement permits the testing of the correct settings of the variables that are responsible for the dimensional reproduction of the workpieces in the negative shape (sintering behaviour—completion of the oven settings given a sintering oven) and permits information of the volume behaviour and compression (shortening of the paths) of the workpieces.

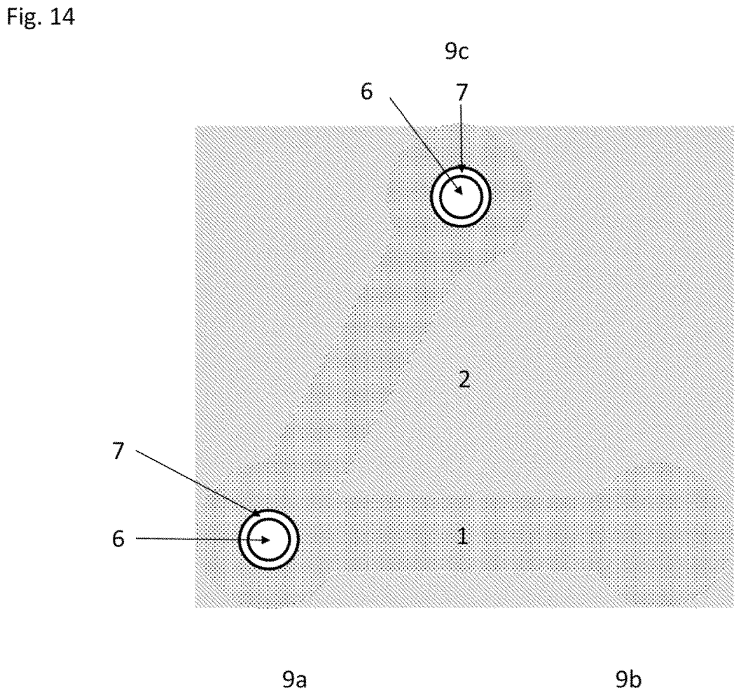

FIG. 14 shows a test body according to the invention (positive part (2) and negative part (1)) with three posts (9a, 9b and 9c) in a view from above. The three posts (9a, 9b and 9c) include a central channel (6) with a step (7). The positive part (2) is cube-shaped. The negative part (1) consists of three posts (9a, 9b and 9c) which are connected to one another by way of two connectors which form the base body of the negative part. The shown test body includes three posts in an arrangement that corresponds to the actually occurring post distribution in one of the two jaws. The negative part, which includes two connectors but which includes no base body between two of the three posts, permits an additional control of the sintering behaviour of the material. This type of post arrangement is very often used with wide-spanning or long spanning tooth gaps, which are to be provided with so-called bridge parts.

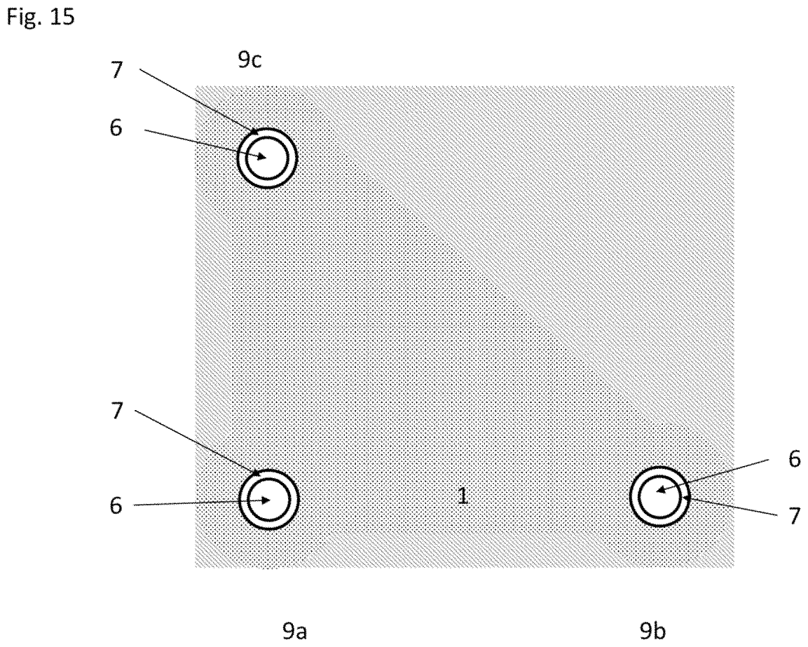

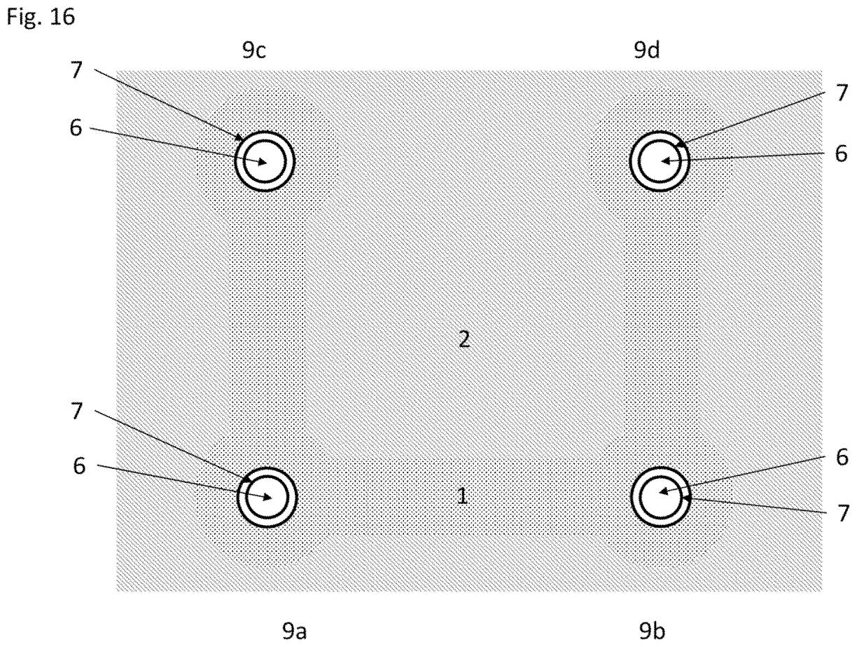

FIG. 15 shows a further test body according to the invention (positive part (2) and negative part (1)) with three posts (9a, 9b and 9c) in a view from above, wherein the shape of the base body of the negative part varies. All three posts (9a, 9b and 9c) include a central channel (6) with a step (7), wherein the channels reach through the base body. The negative part (1) consists of three posts (9a, 9b and 9c), which are connected to one another by way of connectors that form the base body of the negative part.

FIG. 16 shows a test body according to the invention (positive part (2) and negative part (1)) with four posts in a view from above. All four posts (9a, 9b, 9c and 9d) include a central channel (6) with a step (7). The positive part (2) has a rectangular base shape. The negative part (1) includes four posts (9a, 9b, 9c and 9d), which are connected to one another by way of three connectors which form the base body of the negative part.

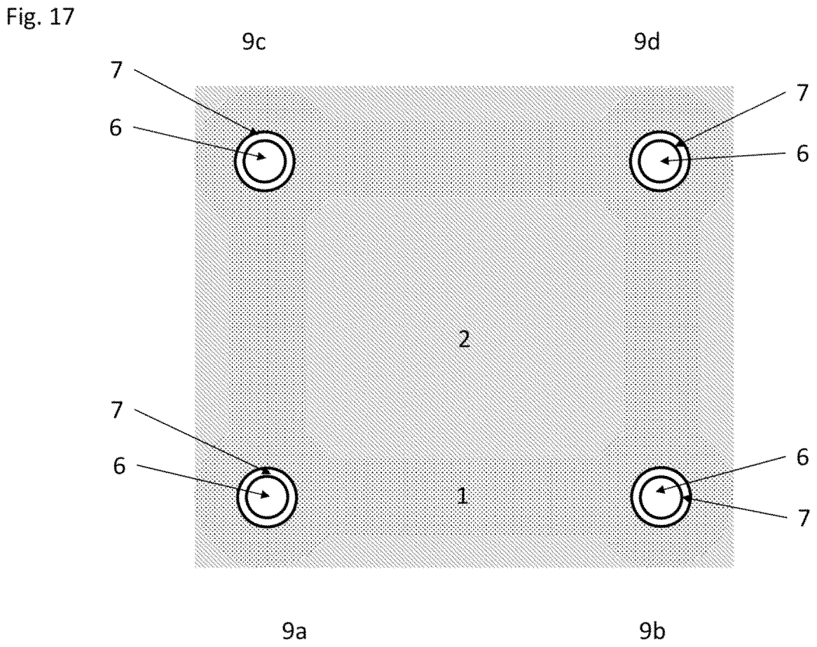

FIG. 17 shows a further test body according to the invention (positive part (2) and negative part (1)) with four posts (9a, 9b, 9c and 9d) in a view from above. The negative part (1) consist of four posts (9a, 9b, 9c and 9d), which are connected one another by way of four connectors which form the base body of the negative part.

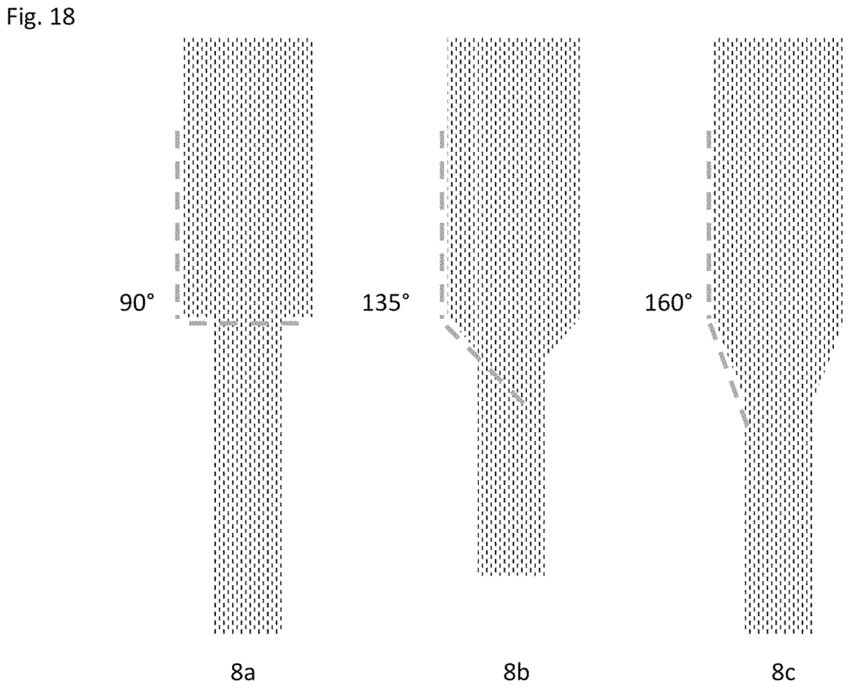

FIG. 18 shows three different test pins (8a, 8b, 8c) that can be used in combination with the test bodies according to the invention. The test pin (8a) includes a step (7), which runs at an angle of 90° (herein always specified as an angle in degrees to the horizontal contact surface). Such a test pin is to be used if the channel (6) in the test body includes a corresponding step (7) with a 90° angle (inner angle; or 180° outer angle). The test pin (8b) has a tapering, which runs at an angle of 135°, and the test pin (8c) has a step of 160°. Both test pins can only applied if the channel (6) in the test body has a corresponding step.

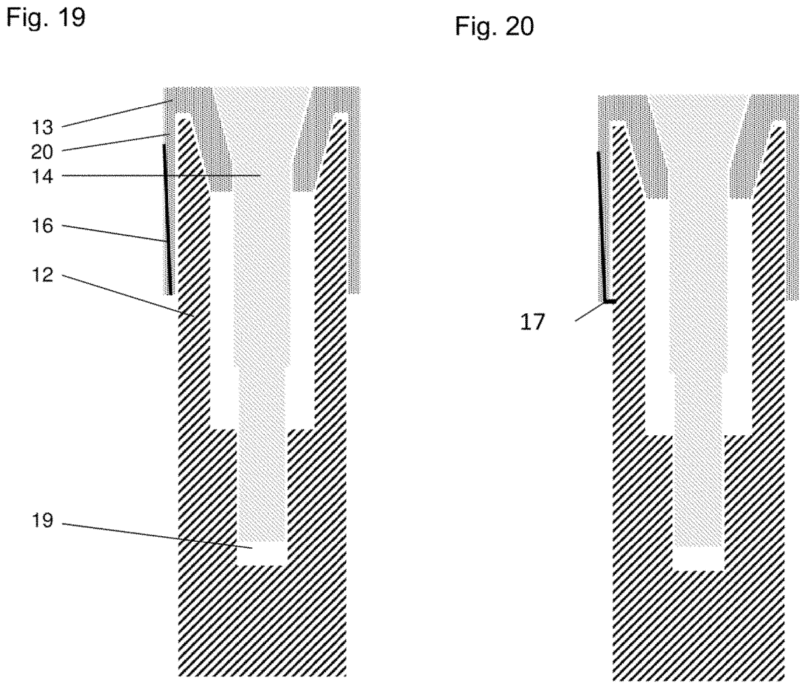

FIG. 19 shows a dental implant system 1, including an implant 12 and a prosthetic component 13, as well as a fastening means 14, by way of which the prosthetic component 13 is fastened to the implant 12. In the shown example, the fastening means 14 is designed as a screw, which, e.g., engages into a fastening means recess 19 of the implant 12, which is designed as a screw thread. The prosthetic component here is only stylised and partly shown. Herein, it can be an abutment, a crown or an outer sleeve.

The prosthetic component 13, which is designed as an abutment in this example, includes a so-called jacket, thus an apically extending region which encompasses the implant 12 from the outside. Such a jacket can be used in order to define the gap between the implant 12 and the abutment 13 in a precise manner and to determine the degree of the over-capping. A computer implemented method according to the invention can be used to determine the optimal, vertical contouring 16 of the jacket 20 of the prosthetic component 13. This should be adapted to the situations in the mouth of the patient, e.g., gum edge and crown contour.

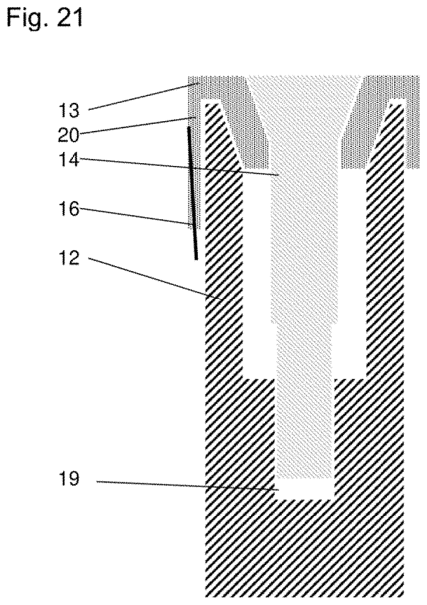

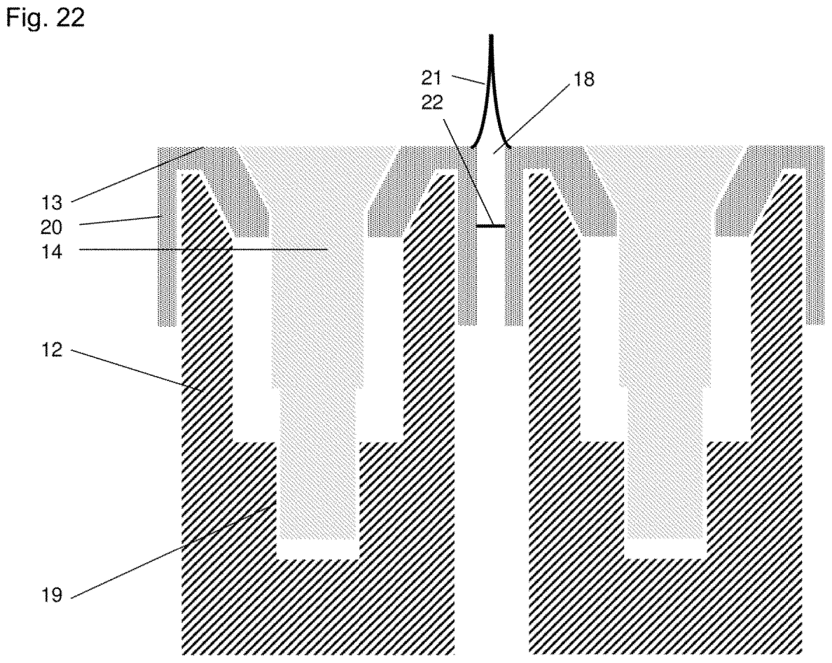

The horizontal contouring 17 is schematically shown in FIG. 20 and this is a further parameter that can be determined with the computer-implemented methods according to the invention. Added to this as parameters are the degree or length of the over-capping or push-over which can also vary in the periphery of the jacket 20, as is shown in FIG. 21.

A further important parameter is illustrated in the schematic drawing of FIG. 22. The computer-implemented method according to the invention can also serve for planning the intermediate space design 18 between the two adjacent teeth or tooth replacement structures. Herein, the distance 22 of correspondence points of adjacent structures, the height of the jawbone as well as the fashioning of the approximal surfaces 21 plays a role. The distance 22 may not fall below a critical minimum for shaping out harmonic soft tissue in the intermediate space (gingival papilla), since otherwise the hard tissue and soft tissue would be too greatly compressed. This compromising of the “biological width” inevitably leads to inflammation, possibly accompanied by the loss of tissue. If the distance 22 between adjacent structures increases, then there exits the risk of a very flat course of the soft tissue without papilla peaks, if the intermediate space 18 is not narrowed by a correspondingly protruding contour of the crowns. A suitable tightness of the intermediate space 18 is desirable since by way of this the soft tissue is laterally supported and can be pulled up to the contact point between the crowns of adjacent structures. The computer-implemented method ensures that the parameters which are necessary for the shaping of anatomical papillae (e.g., distance 22, bone height, contour of the crowns in the approximal region) are put in a suitable mutual relation to one another.

1. A method for calibrating a data acquisition device and a peripheral device, comprising the following steps:
a) providing a standardized test body which consists of a positive part and a negative part and comprises a standardized, digital data set of the three-dimensional data of the negative part of the test body as a shape master;
b) acquiring three-dimensional data of the positive part of the standardized test body from a) by the data acquisition device to be calibrated and generating a corresponding digital data set of the positive part of the standardized test body;
c) importing the digital data set from b) into CAD software and loading a standardized, digital data set from a);
d) designing the negative part with the help of the digital data set from b), the standardized digital data set from a) and the CAD software from c);
e) producing the negative part amid the use of the design from d) and the peripheral device to be calibrated; and
f) examining the fitting accuracy between the negative part from step e) and the positive part of the standardized test body from a).

2. A method for calibrating a data acquisition device and a peripheral device, comprising the following steps:
a) providing a standardized test body which consists of a positive part and of a negative part, and a standardized digital data set which comprises the three-dimensional data of the positive part of the test body as a shape master;
b) acquiring three-dimensional data of the negative part of the standardized test body with the data acquisition device to be calibrated and generating a corresponding digital data set of the negative part of the standardized test body,
c) importing the digital data set from b) into CAD software and loading the standardized digital data set from a);
d) designing the positive part with the help of the digital data set from b), the standardized digital data set from a) and the CAD software from c);
e) producing the positive part amid the use of the design from d) and the peripheral device to be calibrated; and
f) examining the fitting accuracy between the positive part from step e) and the negative part of the standardized test body from a).

3. The method of claim 1, comprising the further steps of:
g) repeating the steps c) to f) and herein adapting or optimizing the parameters of the CAD software and the device parameters until the fitting accuracy in step f) lies in the range of predefined tolerances and
h) acquiring and storing the adapted parameters of the CAD software and of the calibrated devices.

4. The method of claim 1, wherein in step b), the acquisition of the three-dimensional data of the negative part or positive part is effected by scanning.

5. The method of claim 1, wherein the digital data set which is created in b) and the standardized data set are present and transferred in .stl format.

6. The method of claim 1, wherein step d) comprises a matching of the three-dimensional, digital data from b) and of the standardized digital data set from a).

7. A test body for calibrating a data acquisition device and a peripheral device, wherein the test body consists of a positive part and a negative part, and wherein the positive part and the negative part engage into one another such that at least one horizontal contact surface, a Morse taper and an oblique contact surface exist, wherein the oblique contact surface reaches to the surface of the test body.

8. The test body according to claim 7, wherein the oblique contact surface ends at the periphery of the test body.

9. The test body according to claim 7, wherein the test body consist of a shape-stable material.

10. The test body according to claim 7, wherein the positive part and the negative part of the test body have been manufactured of different materials.

11. The test body according to claim 7, wherein the test body comprises at least one channel which permits the insertion of a test pin into the test body of the positive part and the negative part.

12. The test body according to claim 11, wherein the at least one channel in its course has a step in the inside.

13. The test body according to claim 7, wherein the positive part and the negative part comprise a base body and at least one post.

14. A set consisting of a test body according to claim 7 and at least one test pin that can be inserted into the at least one channel of the test body.

15. The set according to claim 14, further comprising at least one standardized, digital data set of the positive part of the test body and at least one standardized, digital data set of the negative part of the test body.
